(19) United States
(12) Patent Application Publication
(10) Pub. No.: US 2023/0315414 A1
(43) Pub. Date: Oct. 5, 2023

(54) SEARCHING NEURAL NETWORK PIPELINES BASED ON NAMED MATRIX DIMENSIONS

(71) Applicant: SambaNova Systems, Inc., Palo Alto, CA (US)

(72) Inventors: Bowen YANG, Palo Alto, CA (US); Fei WANG, Palo Alto, CA (US); Shengyue HUO, Sunnyvale, CA (US)

(73) Assignees: SambaNova Systems, Inc., Palo Alto, CA (US); SambaNova Systems, Inc., Palo Alto, CA (US)

(21) Appl. No.: 18/128,104

(22) Filed: Mar. 29, 2023

Related U.S. Application Data
(60) Provisional application No. 63/327,313, filed on Apr. 4, 2022.

(51) Int. Cl. G06F 8/41; G06F 16/22

(52) U.S. Cl. CPC G06F 8/45; G06F 16/2237

(57) ABSTRACT

A method comprises a compiler determining operators and matrices of an application model. The compiler generates a dimension-based search space (DBSS) comprising Named Nodes corresponding to the operators. The Named Nodes comprise a Named DIM corresponding to a matrix associated with an operator. The Named DIM comprises a DIM Name corresponding to a dimension of a row or column of the matrix. The DBSS comprises an application programming interface (API) to determine operators, matrices, and/or attributes of operators/matrices of the application model using the DIM Names. The method includes the compiler determining the operator, the matrix, and the Named DIM and generating an entry in the DBSS that includes a Named Node corresponding to the operator, a Named DIM corresponding to the matrix and including the DIM Name. A computing system and/or a computer program product can implement the method.

### CROSS-REFERENCE AND INCORPORATIONS

This application further claims the benefit of U.S. Provisional Patent Application No. 63/327,313 filed Apr. 4, 2022, which is incorporated by reference herein in its entirety.

The following are incorporated by reference for all purposes as if fully set forth herein:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.
U.S. Nonprovisional patent application Ser. No. 16/239,252, filed Jan. 3, 2019, titled “VIRTUALIZATION OF A RECONFIGURABLE DATA PROCESSOR,” (Attorney Docket No. SBNV 1000-1);
U.S. Nonprovisional patent application Ser. No. 16/536,192, filed Aug. 8, 2019, entitled “COMPILER FLOW LOGIC FOR RECONFIGURABLE ARCHITECTURES,” (Attorney Docket No. SBNV 1006-1);
U.S. Nonprovisional patent application Ser. No. 16/572,527, filed Sep. 16, 2019, entitled “PERFORMANCE ESTIMATION-BASED RESOURCE ALLOCATION FOR RECONFIGURABLE ARCHITECTURES,” (Attorney Docket No. SBNV 1016-2);
U.S. patent application Ser. No. 16/922,975, filed Jul. 7, 2020, titled “RUNTIME VIRTUALIZATION OF RECONFIGURABLE DATA FLOW RESOURCES,” (Attorney Docket No. SBNV 1026-1;
U.S. Nonprovisional patent application Ser. No. 17/216,651, filed Mar. 29, 2021, entitled “LOSSLESS TILING IN CONVOLUTION NETWORKS—TILING CONFIGURATION,” (Attorney Docket No. SBNV 1034-2);
U.S. Nonprovisional patent application Ser. No. 17/216,652, filed Mar. 29, 2021, entitled “LOSSLESS TILING IN CONVOLUTION NETWORKS—SECTION BOUNDARIES,” (Attorney Docket No. SBNV 1034-3);
U.S. Nonprovisional patent application Ser. No. 17/384,507, filed Jul. 23, 2021, entitled “LOSSLESS TILING IN CONVOLUTION NETWORKS—BACKWARD PASS,” (Attorney Docket No. SBNV 1034-9); and,
US Nonprovisional patent application titled “SEARCHING CONVOLUTIONAL NETWORK NODES BASED ON NAMED MATRIX DIMENSIONS,” Attorney Docket No. SBNV1109USN01, by Yang, et al.

### FIELD OF THE TECHNOLOGY

The technology disclosed relates to neural networks in machine learning and artificial intelligence computing systems. In particular, the technology disclosed relates to compilers for computing systems using reconfigurable processors, such as coarse-grain reconfigurable processors to execute convolutional neural networks.

### BACKGROUND

The present disclosure relates to compilers for data parallel and dataflow applications and determining allocation of computing system hardware resources to execute such applications. The applications can include machine learning, Artificial Intelligence, and convolutional neural networks.

### BRIEF DESCRIPTION OF THE DRAWINGS

The drawings included in the present disclosure are incorporated into, and form part of, the specification. They illustrate implementations of the present disclosure (hereinafter, “the disclosure) and, along with the description, serve to explain the principles of the disclosure. The drawings are intended to be only illustrative of certain implementations and are not intended to limit the disclosure.

FIG. 1 illustrates an example CGR system, according to aspects of the disclosure.

FIG. 2 illustrates an example sub-graph of an application model graph, according to aspects of the disclosure.

FIG. 3 illustrates an example compiler stack, according to aspects of the disclosure.

FIG. 4 illustrates an example mapping decision space, according to aspects of the disclosure.

FIG. 5 illustrates an example system dimension-based search space, according to aspects of the disclosure.

FIG. 6 illustrates an example method to generate a dimension-based search space, according to aspects of the disclosure.

FIG. 7 illustrates an example system comprising an application model compiler and dimension-based search space, according to aspects of the disclosure.

FIG. 8 illustrates an example system for executing a compiler to generate a dimension-based search space, according to aspects of the disclosure.

In the figures, like reference numbers can indicate functionally similar elements. The systems and methods illustrated in the figures, and described in the Detailed Description below, can be arranged and designed in a wide variety of different implementations. Neither the figures nor the Detailed Description are intended to limit the scope of the claims. Instead, they merely represent examples of different implementations of the disclosed technology.

### SUMMARY

A method comprises a computing system generating a dimension-based search space (DBSS) comprising a plurality of Named Nodes. Each of the Named Nodes corresponds to a respective operator of an application model and a Named DIM corresponding to a matrix associated with the respective operator. The Named DIM includes a DIM Name, among a set of DIM Names, corresponding to a dimension of a row and/or column of a matrix of the respective operator. In the method the computing system determines an operator, among operators of the application model, and a matrix among matrices associated with the operator. The computing system determines a DIM Name to associated with a dimension of the matrix. The DBSS includes an application programming interface (API) that the computing system can use to query the DBSS to determine operators, matrices, and/or attributes of operators/matrices, of the application model based on the DIM Names.

In the method, the computing system can determine a DIM Name of a second dimension of the matrix. In the method the computing system can determine the DIM Name of the second dimension to be different from the DIM Name of the first dimension. In the method the computing system can, additionally, determine a second DIM Name corresponding to a dimension of a second matrix of the application model. The computing system can determine the second DIM Name to be the same as the first DIM Name or to be different from the first DIM Name.

A computing system comprising a compiler and a DBSS can perform the method. A computer programming product can include programming instructions to perform the method.

### SUMMARY

A method comprises a computing system generating a dimension-based search space (DBSS) comprising a plurality of Named Nodes. Each of the Named Nodes corresponds to a respective operator among a plurality of operators of an application model and comprises a Named DIM. Each of the Named DIMS corresponds to a matrix of the application model and is associated with the respective operator. Each Named DIM comprises a DIM Name among a set of DIM Names included in the DBSS. Each DIM Name is associated with a dimension of the matrix associated with the respective operator.

The DBSS comprising an application programming interface (API) usable by a computing system to determine, based on a query DIM Name among the set of DIM Names, at least one of an attribute of an operator, among the plurality of operators of the application model, and an attribute of a matrix among matrices of the application model.

The method furthers includes the computing system: determining an operator among operators of an application model; determining a matrix of the application model associated with the first operator; determining a DIM Name, among the set of DIM Names, corresponding to a dimension of the matrix; and, generating, in the DBSS, Named Node corresponding to the operator, The Named Node comprises a Named DIM corresponding to the matrix and comprises the first DIM Name.

A computer program product and a computing system can implement the method.

### DETAILED DESCRIPTION

Aspects of the present disclosure (hereinafter, “the disclosure”) relate to methods of compiling neural network applications for execution on computing systems utilizing reconfigurable dataflow processing elements, in particular utilizing coarse-grain reconfigurable processors (CGRPs). More particular aspects relate to determining mappings of neural network operators and data flow to CGRP processing and/or memory elements, and/or configurations of CGRP processing and/or memory elements. Implementations of the disclosure (hereinafter, “implementations”) can analyze a computation graph of a machine learning model to determine alternative mappings.

Processing elements that implement aspects of the disclosure can include processors of data parallel (DP) and/or dataflow computing systems, such as Central Processing Unit (CPUs), Graphics Processing Units (GPUs), Field Programmable Gate Arrays (FPGAs), and Digital Signal Processors (DSPs). Certain aspects of the disclosure relate to executing neural networks on computing systems utilizing reconfigurable processor architectures, such as CGRPs, reconfigurable Application Specific Integrated Circuits (ASICs), and/or Application Specific Instruction-set Processors (ASIP).

Implementations that are not mutually exclusive are taught to be combinable. One or more features of an implementation can be combined with other implementations. The disclosure in some instances repeats references to these options. However, omission from some implementations of recitations that repeat these options should not be taken as limiting the combinations taught in the preceding sections—these recitations are hereby incorporated forward by reference into each of the following implementations.

Particular expressions of the disclosure will be understood to have the following operative meanings:
The phrases “at least one”; “one or more”; and “and/or” are to be understood as open-ended expressions that operate both conjunctively and disjunctively. For example, each of the expressions “at least one of A, B, and C”, “at least one of A, B, or C”, “one or more of A, B, and C”, “one or more of A, B, or C”, and “one or more of A, B, and/or C” means A alone, B alone, C alone, A and B together, A and C together, B and C together, or A, B, and C together.
The term “a” or “an” entity refers to one or more of that entity. As such, the terms “a”/“an”, “one or more”, and “at least one” can be used interchangeably herein.
The terms “comprising”, “including”, and “having” can be used interchangeably herein.

Unless otherwise specified, the use of ordinal adjectives first, second, third, etc., to describe an object, merely refers to different instances or classes of the object and does not imply any ranking or sequence.

As used herein, “incorporated subject matter” refers, collectively, to subject matter disclosed, and/or otherwise encompassed, among the disclosures incorporated herein by reference. For purposes of illustrating the disclosure, but not intended to limit implementations, various terms of the disclosure are drawn from the incorporated subject matter. As used herein, unless expressly stated otherwise, such terms as can be found in the incorporated subject matter have the same meanings, herein, as their meanings in their respective incorporated disclosures.

Aspects of the disclosure can be appreciated through a discussion of example implementations and/or applications of methods and/or systems. However, such examples are for purposes of illustrating the disclosure. It should be understood that the intention is not to limit the disclosure to the example implementations described herein, but to encompass all modifications, equivalents, and alternatives falling within the spirit and scope of the disclosure. Thus, the disclosure is not intended to be limited to the implementations shown but is to be accorded the widest scope consistent with the principles and features disclosed herein. Various modifications to the disclosed examples will be readily appreciated by those of ordinary skill in the art, and the general principles defined herein can be applied to other implementations of the disclosure without departing from the spirit and scope of the disclosure.

The disclosure uses terms and acronyms related to the field of the technology, defined, at least in part, herein as:

AI—artificial intelligence.

AIR—arithmetic or algebraic intermediate representation.

ALN—array-level network.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

CGR unit—a circuit that can be configured and reconfigured to locally store data (e.g., a memory unit or a partition memory unit, such as described in Prabhakar), or to execute a programmable function (e.g., a processor or other compute unit, or a partition compute unit such as described in Prabhakar). A CGR unit includes hardwired functionality that performs a limited number of functions used in computation graphs and dataflow graphs. Some implementations include switches to route data among CGR units.

CGR Array—an array of CGR units, coupled with each other through an array-level network (ALN), and coupled with external elements via a top-level network (TLN). In implementations a CGR array can physically implement the nodes and edges of a computation and/or dataflow graph.

CGRP—Coarse-grain reconfigurable processor. As used herein, CGRP refers to a processor, or processing element, based on a CGRA—such as an integrated circuit, chip, or module based on, or incorporating, a CGRA—and/or incorporates a CGR unit, CGR array, or elements of a CGR unit and/or a CGR array.

CGR Components—As used herein, “CGR components” refers, collectively, to hardware resources or elements of CGR units, CGR arrays, and CGRP; memories of CGR units/arrays/processors; and, networks and/or I/O interconnections and interface hardware interconnecting CGR units/arrays/processors and/or memories, such as Ethernet networks/interfaces, I/O buses/interfaces, such as PCI-Express buses, InfiniBand buses/interfaces, and/or memory or data buses/interfaces, such as buses of a processor and/or memory fabric, and related interface hardware).

CGR hardware—As used herein, the terms “CGR hardware” and “CGR hardware resources” refer to any individual hardware element, or combination of hardware elements, of CGR components of a CGRS.

CGRS—a computing system comprising CGR units and/or CGRPs. As used herein, CGRS refers to a computing system that is based on, and/or can utilize, reconfigurable computing resources, such as CGR arrays, CGR units, and/or CGRPs, to perform operations of data parallel and/or dataflow applications. U.S. Nonprovisional patent application Ser. No. 16/239,252, “VIRTUALIZATION OF A RECONFIGURABLE DATA PROCESSOR”, to Grohoski, et al, (hereinafter, “Grohoski”), and U.S. Nonprovisional patent application Ser. No. 16/922,975, “RUNTIME VIRTUALIZATION OF RECONFIGURABLE DATA FLOW RESOURCES”, to Kumar, et al, (hereinafter, “Kumar”), both incorporated herein by reference, illustrate example implementations of CGR arrays, CGR units, CGRPs, and CGR systems.

Chip—As used herein, the term “chip” refers to an IC (or, combination of ICs) that can embody elements of a CGRA. A chip can typically be packaged in a chip module (e.g., a single chip module, “SCM” or, alternatively, a multi-chip module, “MCM”).

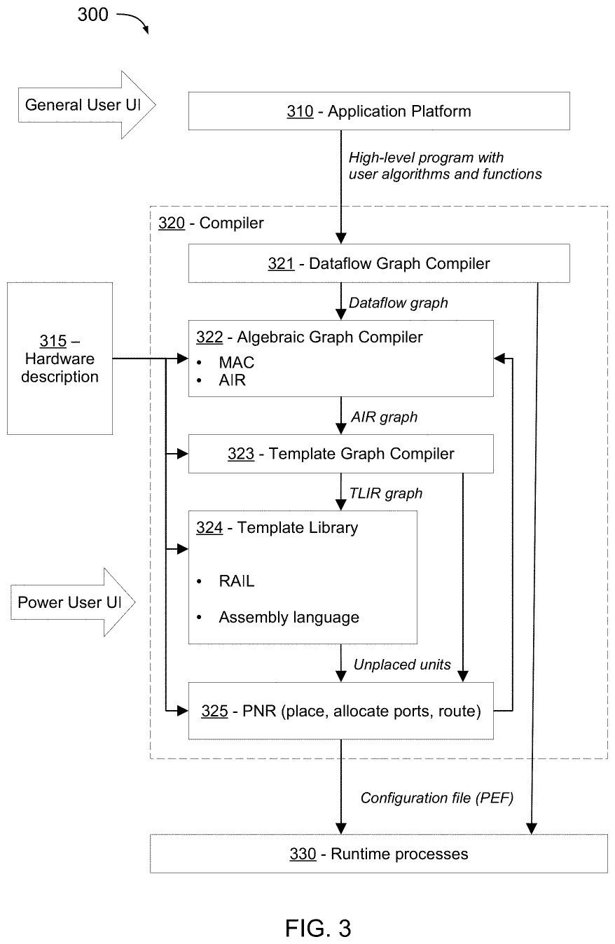

Compiler—a translator that processes statements written in a programming language to machine language instructions for a computer processor. A compiler can include multiple stages to operate in multiple steps. Each stage can create or update an intermediate representation (IR) of the translated statements. Compiler stages are illustrated with reference to FIG. 3.

Computation graph/Graph—As used herein, computation graph refers to a type of directed graph comprising nodes and edges connecting the nodes, to represent a dataflow application. In a neural network application nodes can represent mathematical operations/expressions and edges that indicate dependencies between the operations/expressions. For example, in machine learning (ML) algorithms, input layer nodes can assign variables, output layer nodes can represent algorithm outcomes, and hidden layer nodes can perform operations on the variables. Edges can represent data (e.g., scalars, vectors, tensors) flowing between operations. In addition to dependencies, the computation graph reveals which operations and/or expressions can be executed concurrently.

Dataflow Application—As used herein, the term “dataflow” application refers interchangeably to data parallel and dataflow applications. such as ML, AI, and other massively parallel computing applications.

Dataflow Graph—a computation graph, or portion of a computation graph, corresponding to operators (application compute functions), data, and flow of data among operators, of a dataflow application that includes one or more loops of operator nodes that can be nested, and wherein nodes can send messages to nodes in earlier (predecessor) layers to control the dataflow between the layers.

IC—integrated circuit—a monolithically integrated circuit, i.e., a single semiconductor die which can be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

Intermediate Representation (IR)—an Intermediate Representation is a representation of an application model in an intermediate langue. An IR can incorporate partial compilation results, such as sections (groupings) of a graph or model, pipelines that can be formed within a graph or model, mappings of application functions or graph nodes/edges to hardware resources of a CGRS.

Logical CGR—A logical CGR array or logical CGR unit comprises a representation of a CGR array or a CGR unit that is physically realizable, but that may not, at a particular time in executing a dataflow application, have been assigned to a physical CGR array or to a physical CGR unit on an IC.

ML—machine learning.

PEF—processor-executable format—a file format suitable for configuring a configurable data processor.

Pipeline—a staggered flow of computational operations through a chain of pipeline stages in which the operations can be executed in parallel. In an application graph, a pipeline can comprise a set of operator nodes that can pipeline operations of the graph.

Pipeline Stages—a pipeline can be divided into stages that are coupled with one another as predecessor/successor stage to form a pipe topology.

PNR—place and route—the assignment of logical CGR units and associated processing/operations to physical CGR units in an array, and the configuration of communication paths between the physical CGR units.

RAIL—reconfigurable unit abstract intermediate language.

RP—reconfigurable processor. An RP can comprise, for example, field programmable gate arrays (FPGAs), graphic processing units (GPUs), and/or CGRPs.

TLIR—template library intermediate representation (IR).

TLN—top-level network.

Turning now to more particular aspects of the disclosure, high-level programs for machine learning (ML) and artificial intelligence (AI) can require massively parallel computations, where many parallel and interdependent computation threads (pipelines) exchange data. Such programs are ill-suited for execution on traditional, Von Neumann architecture computers. Rather, these applications can require architectures optimized for parallel and pipeline processing, such as CGRAs or graphic processing units (GPUs).

The ascent of dataflow applications such as ML and AI, and massively parallel architectures (such as CGRAs) places new and complex requirements to execute the applications, or computations of the applications, on CGR hardware. Such requirements can include how computations of an application are pipelined, which computations are assigned to which compute units, how data is routed between various compute units and memories, and how synchronization among processors, memories, and data transfer hardware is controlled, particularly when a dataflow applications includes one or more nested loops, whose execution time can varies depending on the data being processed. The architecture, configurability and dataflow capabilities of CGR systems, and CGR components of CGR systems, enable increased compute power that supports both parallel and pipelined computation.

In implementations CGR components of a CGRS, for example, can be programmed to simultaneously execute multiple independent and interdependent operations. To enable simultaneous execution within a pipeline stage, and across pipeline stages, dataflow applications need to be distilled from a high-level program and translated to low level instructions to execute the program on hardware resources of reconfigurable dataflow systems, such as a CGRS. The low level instructions can comprise a configuration file describing a configuration of CGR components, as well as processor (e.g., CGRP) instructions and/or instructions for transferring application data among CGR components.

A high-level program is source code written in programming languages like Spatial, Python, C++, and C, and can use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

In computing applications, a compiler translates high-level programs to instruction executable by processors of a computing system. In a CGRS, a CGRS compiler can translate high-level programs to processor instructions, but also to executable instruction files and/or “bit files” describing configurations of CGR components to execute a dataflow application, or pipeline stages of a dataflow application. CGRS compilers require mapping application operations and data flow to CGR hardware components in both space (CGR hardware parallelism) and time (for synchronization of interdependent computations). This requirement implies that a CGRS compiler must determine which operations of a dataflow application are assigned to which of the CGR components, and how both data and, related to the support of computation and control information flow among CGR components, and to/from external hosts and storage. This process, known as “place and route”, is one of many new challenges posed to CGRS compilers.

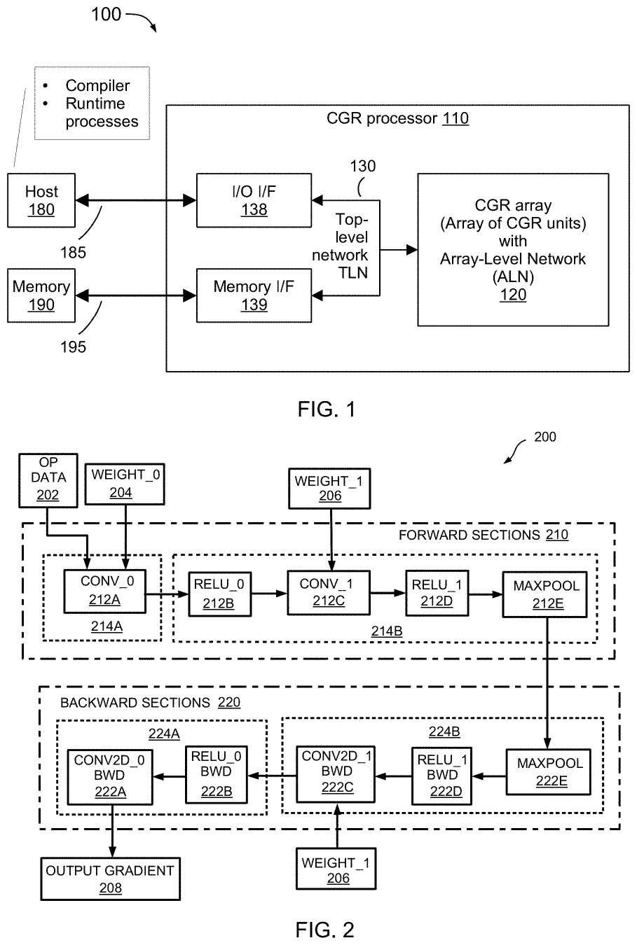

FIG. 1 illustrates an example reconfigurable dataflow computing system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via data bus 130 which can be part of a top-level network (TLN). Host 180 communicates with IO interface 138 via system data bus 185, and memory interface 139 communicates with memory 190 via memory bus 195. Array of CGR units 120 can further include compute units and memory units that connected with an array-level network (ALN) to provide the circuitry for execution of a computation graph or a dataflow graph that can have been derived from a high-level program with user algorithms and functions. The high-level program can include a set of procedures, such as learning or inferencing in an AI or ML system. More specifically, the high-level program can include applications, graphs, application graphs, user applications, computation graphs, control flow graphs, dataflow graphs, models, deep learning applications, deep learning neural networks, programs, program images, jobs, tasks and/or any other procedures and functions that can need serial and/or parallel processing. In some implementations, execution of the graph(s) can involve using multiple units of CGR processor 110. In some implementations, CGR processor 110 can include one or more ICs. In other implementations, a single IC can span multiple CGR processors. In further implementations, CGR processor 110 can include one or more units of array of CGR units 120.

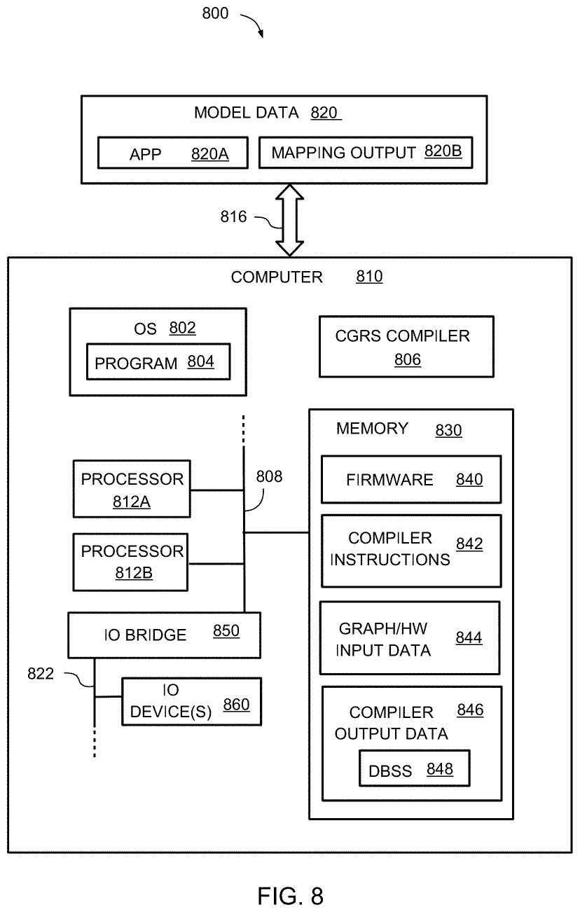

Host 180 can be, or can include, a computer such as further described with reference to FIG. 8. Host 180 runs runtime processes, as further referenced herein, and can also be used to run computer programs, such as a CGRS compiler. In some implementations, the compiler can run on a computer that is similar to the computer described with reference to FIG. 8, but separate from host 180.

CGR processor 110 can accomplish computational tasks by executing a configuration file (for example, a PEF file). For the purposes of this description, a configuration file corresponds to a dataflow graph, or a translation of a dataflow graph, and can further include initialization data. A compiler compiles the high-level program to provide the configuration file. In some implementations described herein, a CGR array is configured by programming one or more configuration stores with all or parts of the configuration file. A single configuration store can be at the level of the CGR processor or the CGR array, or a CGR unit can include an individual configuration store. The configuration file can include configuration data for the CGR array and CGR units in the CGR array, and link the computation graph to the CGR array. Execution of the configuration file by CGR processor 110 causes the CGR array (s) to implement the user algorithms and functions in the dataflow graph.

CGR processor 110 can be implemented on a single integrated circuit die or on a multichip module (MCM). An IC can be packaged in a single chip module or a multichip module. An MCM is an electronic package that can comprise multiple IC dies and other devices, assembled into a single module as if it were a single device. The various dies of an MCM can be mounted on a substrate, and the bare dies of the substrate are electrically coupled to the surface or to each other using for some examples, wire bonding, tape bonding or flip-chip bonding.

Many dataflow applications, such as in ML and other types of AI applications, comprise neural networks (NNs). Examples of neural networks include fully connected neural networks (FCNNs), recurrent neural networks (RNNs), graph neural networks (GNNs), convolutional neural networks (CVNNs), graph convolutional networks (GCNs), long short-term memory (LSTM) networks, autoencoders, deep belief networks, and generative adversarial networks (GANs).

In data parallel and dataflow applications, such as NNs, compute functions of the application are often referred to as “operators”. The compute functions perform computations, such as matrix computations using tensor data of the application, to execute the higher level processes of the application (e.g., object recognition in an image, natural language phrase interpretations or prediction, etc.). A neural network processes data according to a flow of computational input (operand) and computational output (results) data through layers of operators (neurons) of the NN.

Operators of an input layer can receive stimuli (e.g., input data), and the input and other (e.g., “hidden”) layers compute particular functions (e.g., an activation or loss function), and operators of an output layer output computational results. A particular layer of an NN comprises operators that perform the particular function computations of that layer. Example layers, and associated operators, of NNs include rectified linear unit (ReLU) layers, fully connected layers, recurrent layers, graphical network layers, long short-term memory layers, convolutional layers, kernel layers, dropout layers, and pooling layers.

A machine learning application requires “training” within a problem space the application is designed to recognize (e.g., subjects of images, audio, or video) or predict outcomes (e.g., natural language phrase completion, future values, etc.). Training a neural network can comprise determining and/or optimizing parameters associated with computations (e.g., activation functions) of the NN computed by operators within layers of the NN. Weights and biases, for example, can be parameters of a weights-bias activation function of a neural network. In training such an NN, a training (data parallel/dataflow) application can compute gradients of weights and biases, such as by using a loss-function, and can optimize the weights and biases based on an optimization algorithm such as gradient descent. Executing an ML application can utilize the optimized parameters to execute functions of the application.

Problem spaces of a machine learning application, and/or input of dataflow applications in general, can comprise enormous amounts of data, and can often comprise tensor data. Thus, functions of these applications (e.g., operators of neural networks) commonly involve linear algebra computations over tensor data, such as matrix multiplication, transposition, and addition. Algorithms commonly employed in dataflow applications include algorithms such as linear regression and gradient descent over tensors and/or matrices of tensors. Matrices of tensors data can comprise matrices of varying dimensions and a variety of computing systems, including dataflow computing systems, can perform matrix computations, such as GeMM, matrix summation, matrix transposition, gradient computations, and/or backpropagation of matrix computations, to process tensors in dataflow applications such as machine learning in neural networks.

As used herein, brackets and a capital letter, such as [M], is used to refer to a matrix as a whole, while lowercase letters, such as m, are used to refer to an element, or set of elements, of a matrix [M]. For example, an expression such as (w×a) refers, herein, to a multiplication of a set of elements of matrices [W] and [A], such as elements of a row of matrix [W] multiplied by elements of a corresponding column of matrix [A]. The term “element”, in reference herein to a matrix, refers to the contents (e.g., a scalar value) of a row and column cell of the matrix.

A common computation for processing tensors in dataflow applications is a sum of products (dot product) of two matrices. The products comprise products of elements of a row of one multiplicand matrix (a “left side” matrix_multiplied by corresponding elements of a column of a second multiplicand (a “right side” matrix), where the row dimension of the left side matrix and the column dimension of the right side are the same (shared dimension.) As used herein, the term “dot product” refers to a sum of two or more products of a row of a left side matrix multiplicand by a column of a right side matrix. An expression such as (Σw a) refers to a sum-product of elements w and a (e.g., a sum of products w×a for elements of a row of a matrix [W] multiplied by elements of a column of a matrix [A]). As an example, a dot product of elements w₁₁ of matrix [W multiplied by a₁₁ of matrix [A], and w₁₁ multiplied by a₂₁ of matrix [A], is [w₁₁×a₁₁+w₁₁×a₂₁].

A “matrix summation” computation, as used herein, refers to a matrix computation in which a dot product of two multiplicand matrices is added to a matrix addend. A matrix addend can comprise a constant or can comprise a matrix (which can itself be multiplied by a matrix multiplied by a constant) sharing a row dimension of the dot product of two multiplicand matrices. A “weight-bias function”, y=Σw a+b, is one example of such a computation, in which a weights matrix [W] is multiplied by an activation matrix [A] and the dot products, Σw a, for each row/column set of products, is added to elements of a bias matrix [B] . . . .

In implementations, a CGRP, and/or other CGR components of a CGRS, can perform computations (e.g., operators) of applications in a distributed fashion and/or can execute computations as dataflow pipelines that can efficiently exploit CGRS and application model parallelism, and CGR component data locality. Dataflow pipelines of CGRS compute units (e.g., CGRPs and/or CGR arrays) can contain several computational stages, in which each stage can read data from one or more input buffers (e.g., buffers in CGR component memories), can perform computations on the data while using one or more internal buffers to store and retrieve intermediate results, can produce outputs, and can write the outputs to one or more output buffers.

Data parallel and dataflow computing applications can comprise tensor computations, usually involving enormous amounts of data, such as very large and/or numerous matrices of tensor data. For example, machine learning (ML) and other tensor-based applications can comprise a convolutional neural network (NN). While not intended to limit implementations, a convolutional neural network can serve to illustrate aspects of the disclosure. However, it will be appreciated by one of ordinary skill in the art that aspects of the disclosure can apply broadly to a variety of computing applications involving tensor data, and/or executed by data parallel and/or dataflow applications and computing systems.

An NN can comprise layers organized as a pipeline of computations using matrices of tensor data. A layer of the NN can comprise operators performing computations on matrices of tensor data. A particular operator of an NN (or, tensor-based application in general) can perform a matrix computation, such as Generalized Matrix Multiplication (“GeMM”), matrix convolution, and Rectified Linear Units (“ReLU”) corresponding to particular algorithms and/or functions of the application, such as an activation function, gradient descent function, and/or a loss function. A particular layer of an NN can comprise multiple processing elements, such as CGRPs, executing in parallel to perform operator computations of the application using subsets of tensor data. The processing elements of one layer of an NN can output results of their computations to a successor “forward” and/or “backward” layer of the NN.

Various types and/or combinations of computing systems can execute tensor-based applications, and/or operators of tensor-based applications, such as NNs. Data parallel (DP) and dataflow computing systems, particularly systems utilizing CGRPs, can be particularly efficient at executing tensor-based applications. CGRPs can individually, or in combination, execute functions and/or computations of application operators, in parallel and in pipelines, to efficiently execute an application and improve performance of application execution. As used herein, the term “reconfigurable dataflow system (DS)” refers, interchangeably, to data parallel and dataflow computing systems utilizing reconfigurable processors such as CGRPs. An RDS can, for example, efficiently execute tensor-based applications such as convolutional neural networks, and can serve to illustrate aspects of the disclosure without limiting implementations.

A dataflow application can be referred to as an “application model”, and can comprise a variety of differing operators, and the operators can be interconnected in a variety of topologies corresponding to dataflow, and parallelism, of the application model. An application model can express or represent operators, performing particular computations, and, in the case of tensor-based applications, matrices of tensor data. A tensor-based application model can include computations such as linear regression, non-linear regression, Gaussian regression, Support Vector Machine (SVM) regression, Generalized Linear Models, regression trees, shallow and deep neural network models, logistic regression, decision tree, and, “K” nearest neighbor, using matrices of tensor data. As used herein, the term “application model” and, simply, “model” refers to a model of an application expressing, or representing, operators and data (usually, matrices of tensor data) of the application.

One expression, or representation, of an application model is a computation graph (hereinafter, for brevity, simply “graph”), which can be textual, graphical, or a combination of textual and graphical descriptions of operators, operands, and results of computations of the application. A graph can represent the operators (as compute nodes of the graph) of an application model, and their arrangement and/or dependencies (e.g., flow of computational inputs and outputs) among the operators (as edges of the graph). Data nodes of a graph can represent particular application data elements, such as input data for training an ML model. A graph can be a directed acyclic graph (DAG), or can comprise loops, and even nested loops, of operators. As used herein, except where otherwise qualified as “data node”, the term “node” is used herein interchangeably to refer to an operator of an application and a node representation of that operator in a graph.

Forward nodes of a graph can receive outputs of backward nodes (e.g., gradients), and backward nodes can receive updated outputs of forward nodes (e.g., outputs computed using outputs of backward nodes), creating feedback loops within the graph. As nodes within a feedback loop recompute outputs based on the feedback, such nodes are referred to herein as “recompute nodes”.

A pipeline of an application model can comprise a set of forward operators and, optionally, set of backward operators (e.g., backpropagation operators). Each operator within a pipeline can process data output from a predecessor operator, generally in parallel with the predecessor operators as the predecessor operator outputs results of computations over a portion input data.

FIG. 2 illustrates an example of a computation graph corresponding to an application model. As shown in FIG. 2, forward and backward operators of an application model can be grouped, such as for mapping the operators to CGR components for execution, as respective forward and backward sections of a graph. The sections can each represent nodes of the graph that do not have data dependencies among each other (that is, do not need to await complete computational results of another compute node), such that a CGRS can execute computations of the nodes in a pipeline topology among CGR components. Sections can particularly comprise operators that are “adjacent” and, based on not having data dependencies among each other, can form a pipeline. A “producer” operator and a “consumer” operator are adjacent operators in a graph if the producer can input results of the producer operator computations to an operand of the consumer operator. For example, a GeMM operator is adjacent to an ADD operator if a results matrix (or elements of a results matrix) of the GeMM operator can be direct input to the ADD operator.

In FIG. 2, forward sections 210 is shown comprising Pipe 214A and Pipe 214B, and backward sections 220 is shown comprising Pipe 224A and Pipe 224B. Pipe 214A is shown comprising node CONV_0 212A, and Pipe 224B is shown comprising nodes RELU_0 212B, CONV_1 212C, RELU_1 212D, and MAXPOOL 212E (hereinafter, collectively “nodes 212). Names of nodes, such a “RELU_0”, can indicate a type of computation of the application model performed by a node.

Edges of a graph can represent data flow between and into or out of the nodes. Thus, computational results of node CONV_0 212A can flow as inputs to node RELU_0 212B, computational results of node RELU_0 212B can flow as inputs to node CONV_1 212C, and so forth. Data nodes in a graph can represent data processed by compute nodes and flow of data into or out of the nodes (as also shown in FIG. 2 by directed arrows). In forward sections 210, FIG. 2 depicts data nodes OP DATA 202 and WEIGHT_0 204 as data input to CONV_0 212A, and WEIGHT_1 206 as data input to CONV_1 212C.

In FIG. 2, backward sections 220 is shown comprising Pipe 2224A and Pipe 224B, Pipe 224A is shown comprising nodes CONV2D_0 BWD 222A and RELU_0 BWD 222B, and Pipe 224A is shown comprising nodes CONV2D_1 BWD 222C, RELU_1 BWD 222D, and MAXPOOL 222E. In backward sections 220, FIG. 2 depicts data node WEIGHT_1 206 as data input also to CONV2D_1 222C. Backward nodes of a graph can represent nodes that receive outputs of forward nodes and compute a feedback function over those outputs. For example, a common backward computation is to compute gradients of weights and biases, and/or loss functions based on gradients of weights and biases, in a weights-bias activation function of a forward node. Backward nodes, can compute, for example, a gradient in an application model that include gradient descent to optimize computations of forward nodes in a feedback loop. As shown, an output of backward sections 220 is data node output gradient 208, output node CONV2D_0 BWD 222A.

In implementations, a “CGRS compiler” can compile a high-level language representing of a data parallel and/or dataflow application to configurations and/or execution instructions to execute the application. For brevity, hereinafter “application” is understood to refer to a data parallel or dataflow programming application for execution by a data parallel and/or dataflow computing system, such as a CGRS.

A CGRS compiler can, for example, transform an application model into, and/or can utilize, a graph such as example graph 200 in FIG. 2. Based on a graph of an application model, a CGRS compiler can generate a search space, and can use the graph and/or search space to determine model operational parallelism and pipelining, and/or to map model dataflow (e.g., nodes and edges of a computation graph) to CGRS and/or CGR hardware resources and dataflow through the resources. A compiler can further transform resource mapping decisions into assembler input for generation of hardware instructions and/or hardware configuration files, such as a Processor Executable Format (PEF) file.

FIG. 3 is a block diagram of example compiler stack 300 comprising multiple compilation stages to compile a dataflow application for execution by a CGRS. As depicted in FIG. 3, compiler stack 300 includes several stages to translate a high-level program, with (user) dataflow application algorithms and functions (e.g., ML algorithms and/or tensor computation functions), to configuration and/or instruction data for a CGRS to execute the application.

Compiler stack 300 can take its input from application platform 310, and/or any other source of high-level program statements of an application, which provides a user interface, such as an API and/or command line interface (CLI), for application developers to compile an application. A “user”, as used herein, can be any human or computing system that develops an application (e.g., programs the high-level programs of an application), and/or that can input an application into a CGRS compiler for translation to CGRS configurations and/or CGRS execution instructions.

Compiler stack 300 can further receive hardware description 315, which can comprise a textual and/or graphical description of CGRS and/or CGR hardware components of a CGRS. Compiler stack 300 can utilize hardware description 315 to translate the high-level programming statements of an application to configurations CGR components and/or execution instructions (e.g., instructions to a runtime processor to control execution, and/or processor instructions to execute functions, of an application) to execute the application.

Application platform 310 can comprise a computing system for developing an application and/or inputting an application for compilation by a CGRS compiler. For example, application platform 310 can comprise a computing system capable of hosting a user, such as host processor in the CGRS examples of Kumar. Application platform 310 can include libraries such as PyTorch, TensorFlow, ONNX, Caffe, and Keras to provide user-selected and configured algorithms.

Application platform 310 can output a high-level program of an application to compiler 320, which in turn can output a configuration file to runtime processes 330. Runtime processes 330 can comprise programs to configure CGR components, and/or manage execution of an application on CGR components, of a CGRS. The programs can execute on a runtime processor (e.g., one or more CPUs) of a CGRS.

Compiler 320 can include dataflow graph compiler 321, algebraic graph compiler 322, template graph compiler 323, template library 324, and placer and router PNR 325. In implementations, template library 324 can include a reconfigurable unit abstract intermediate language (RAIL), and/or assembly language interfaces (APIs) for power users.

Dataflow graph compiler 321 can analyze high-level programs, implementing user algorithms and application functions received from application platform 310, and can convert the high-level programs to one or more dataflow graphs. The high-level programs can be suitable for parallel and/or pipeline processing and nodes of the dataflow graphs can be intrinsically parallel unless an edge in the graph indicates a dependency. Dataflow graph compiler 321 can provide code optimization steps, such as false data dependency elimination, dead-code elimination, and numeric constant folding. The dataflow graphs can encode data and execution control dependencies of the high-level programs.

Dataflow graph compiler 321 can support programming a CGR components (e.g., CGRPs) using higher or lower-level programming languages, For example dataflow graph compiler 321 can support translation or conversion from an application platform 310 to C++ and/or an assembly language. In implementations, dataflow graph compiler 321 can allow programmers to provide code (e.g., machine language code) that runs directly on CGRPs and/or other CGR components. Dataflow graph compiler 321 can include one or more programming libraries, and the libraries can include predefined functions, such as linear algebra operations, element-wise tensor operations, non-linear functions, and reduction functions for creating, executing, and profiling dataflow graphs on the CGRPs. Via the application platform 310,m dataflow graph compiler 321 can provide an API to enhance programming functionality available to application developers.

Algebraic graph compiler 322 can include a Model Analyzer and Compiler (MAC) level that can make high-level mapping decisions for sub-graphs (also referred to as “sections” or “section cuts”) of a dataflow graph based on CGR hardware constraints. Algebraic graph compiler 322 can support various application frontends, such as Samba, JAX, and TensorFlow/HLO. Algebraic graph compiler 322 can also transform the graphs, for example via autodiff and GradNorm, to perform stitching between sub-graphs, interface with template generators for performance and latency estimation, convert dataflow graph operations to algebraic intermediate representation (AIR) operations, perform tiling, sharding (database partitioning) and other application preparation operations, and can model or estimate execution parallelism that can be achieved within the dataflow graphs.

Algebraic graph compiler 322 can include an arithmetic or algebraic intermediate representation (AIR) level that can translates high-level dataflow graph and mapping decisions provided by a MAC level into AIR graphs. An AIR level can include validating and/or correcting (“legalizing”) a dataflow graph and/or mapping decisions of a MAC; expanding data parallel, tiling, pipeline, and/or region instructions provided by a MAC; inserting stage buffers and skip buffers, eliminating redundant operations, buffers, and sections; and, optimizing resource use, execution latencies, and computational throughput.

Template graph compiler 323 can translate AIR graphs to a template library intermediate representation (TLIR). A TLIR can comprise a graph that can optimize configurations and/or execution instructions based on target (CGRS and/or CGR) hardware architecture and/or to unplaced units suitable for place, allocate, and route level PNR 325. Template graph compiler 323 can add further information node names, node inputs, node input names, and dataflow descriptions) as inputs to PNR 325, and can make the graph physically realizable through each layer of the graph. Template graph compiler 323 can, for example, translate AIR graphs to specific application model operation templates, such as templates for general matrix multiplication (GeMM), matrix transposition, and/or matrix convolution operations. In implementations a CGRS compiler like compiler 320 a can convert part or all intermediate representation operations to templates, stitch templates into data and control flow of the application, insert necessary buffers and layout transforms, generate test data, and optimize for CGR hardware utilization, execution latency, and compute and/or data transfer throughput.

Implementations can use templates for common operations. Templates can be implemented using assembly language, RAIL, or similar language and/or representation constructs. RAIL can compare to a low-level language, in that memory units and compute units can be separately programmed in RAIL constructs, but RAIL can provide a higher level of abstraction and compiler intelligence that, for example, an assembly language, via a concise performance-oriented and domain-specific language for CGR component (e.g., CGR array) templates. RAIL can enable template writers and external power users to control interactions between logical compute units and memory units of CGR components using high-level expressions, without the need to manually program actions such as capacity splitting, register allocation, etc. RAIL logical compute and memory units can also enable stage/register allocation, context splitting, transpose slotting, resource virtualization and mapping to multiple physical compute units and memory units (e.g., PCUs and PMUs of tiles, such as in the examples of Grohoski and Kumar).

Template library 324 can include an assembler that provides an architecture-independent, low-level programming interface as well as optimization and code generation for CGR hardware. An assembler can include memory address expression compilation, CGR hardware intra-unit resource allocation and management, rendering a template graph physically realizable based on CGR hardware-specific rules, low-level CGR hardware architecture-specific transformations and optimizations, and CGR hardware architecture-specific code generation.

PNR 325 can translate RAIL and/or assembly language outputs of template library 324, and/or TLIR outputs from template graph compiler 323, and can map logical (e.g., unplaced physically realizable) CGR units, to physical CGR hardware implementation levels, such as an SCM, MCM, and/or chip level of CGR components, can determines physical data channels to allow for communication among the CGR units and between the CGR components (e.g., components coupled via a TLN, allocate memory, I/O, and/or switch ports of CGR components, provide CGR component configuration data and initialization data, and can produce configuration files, e.g., processor-executable format (PEF) files. PNR 325 can provide bandwidth calculations, allocate network interfaces, provide configuration data for CGR components to perform memory address translation, and control switch and data routing among CGR components. PNR 325 can perform such functions in multiple steps and can include multiple modules (not shown in FIG. 3) to perform the multiple steps, e.g., a placer, a router, a port allocator, and a PEF file generator). PNR 325 can receive input data, for example, from any of the higher-level modules (dataflow graph compiler 321, algebraic graph compiler 322, template graph compiler 323, and/or template library 324). In implementations, a higher-level module, such as template graph compiler 323, can prepare information for PNR 325 and can omit other levels directly providing input data to PNR 325.

Implementations of compiler 320 compile applications in an iterative process, such as feeding information from PNR 325 back to a higher-level module, which can, in turn, execute a new compilation step using physically realized results, rather than estimates of, or logical placeholders for, physically realizable circuits. For example, PNR 325 can feed information regarding the physically realized circuits back to algebraic graph compiler 322.

Memory allocations can represent logical memory spaces in on-chip (a chip implementing a CGR component) and/or off-chip (a chip separate from a CGR component), CGR component memories, for data flowing through the dataflow graph; a configuration file, such as a PEF, can specify particular memory allocations. Memory allocations can define a type and number of CGR hardware memories and/or circuits (functional units, storage, or connectivity components). Main memories (e.g., DRAM) can be, for example, off-chip memories, and scratchpad memories (e.g., SRAM) can be on-chip memories, such as memories of a CGR array. Memory allocations can correspond to various access patterns and/or memory layouts, such as access patterns/layout of cache memories, read-only look-up tables (LUTs), serial memories (e.g., FIFOs), and/or register files.

Compiler 320 can bind memory allocations to unplaced memory units and can bind operations of a dataflow graph to unplaced compute units, for execution of a graph, and configuration data, such as in a PEF, can specify such bindings. In implementations, compiler 320 can partition parts of a dataflow graph into memory subgraphs and compute subgraphs, and can specify these subgraphs in configuration file. A memory subgraph can comprise, for example, address calculations leading up to a memory access. A compute subgraph can comprise, for example, compute operations (compute nodes) in a parent graph. A compiler can divide a parent graph into multiple memory subgraphs and a single compute subgraph, for example. A single parent graph can produce one or more memory subgraphs, depending on how many memory accesses exist in the original graph loop body. In cases where the same memory addressing logic is shared across multiple memory accesses, a compiler can duplicate address calculations to create multiple memory subgraphs from the same parent graph.

Compiler 320 can generate configuration files with configuration data (e.g., a bit stream) for the placed positions, and for routed data and control networks. In implementations this can include the compiler assigning coordinates and communication resources of the physical CGR components by placing and routing unplaced units of CGR components with a goal to maximize compute and/or data transfer bandwidth and minimizing compute and/or data transfer latency.

An application model may not itself include backward nodes and, in implementations, a CGRS compiler, such as illustrated by the example of compiler 320, can determine that a model requires backward nodes, and can generate backward nodes in a computation graph. In determining a mapping of an application model to CGR hardware resources, a CGRS compiler can identify recompute nodes and can determine section boundaries among forward nodes, backward nodes, and recompute nodes within a graph.

To exploit the full power of a CGRS—particularly, dynamically reconfigurable CGR components of a CGRS—a CGRS compiler must not only generate low level processor instruction sequences, but must also allocate reconfigurable resources of the underlying CGR hardware that can execute the application model most efficiently, and with highest possible computational performance. A CGRS compiler must, further, determine controls to sequence transfer in (e.g., to a memory and/or compute unit), processing (e.g., compute unit and/or operator pipelining), and/or transfer out (e.g., from a memory and/or compute unit) of application data.

In optimizing parallelization and computational latency of among CGRS hardware resources, a CGRS compiler must consider complex factors, such as: the number of available processing units (e.g., processors of CGR components); the number, size, and transfer latency of memory units (e.g., memories of CGR components); computational latency of operators of the application model; dependencies among operators; and, sections of an application model that can execute in parallel, not only intrinsically, but also given the amount of CGRS hardware resources available to execute the sections.

Such considerations can be referred to as “mapping factors”. In implementations “mapping decision space” can comprise mapping factors. In addition, or alternative, to factors just described, the mapping factors can include parameters and/or attributes of an application model and/or CGRS related to mapping factors, such as just described. Mapping factors included in a mapping decision space can include, for example, descriptions and/or attributes of CGR components; configurations and/or arrangements of data nodes, compute nodes, and interconnections of nodes (edges) of a graph and CGR components; and/or, groupings (“section cuts”) of operators of a graph into particular pipelines and sections. Mapping factors of a mapping decision space can include alternative such configurations and section cuts, and can include costs (e.g., hardware utilization, compute and/or data transfer bandwidth or latency) associated with the alternatives. Mapping factors of a mapping decision space can include optimization goals (e.g., optimizing utilization over latency, or vice versa) and/or priorities of execution of particular nodes of a graph.

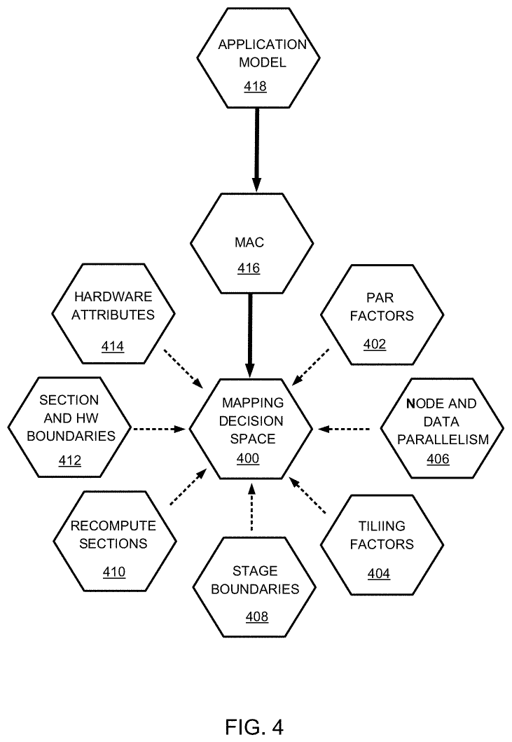

FIG. 4 illustrates mapping factors and a mapping decision space a CGRS compiler can utilize in mapping operators and data of an application model to underlying hardware resources of a CGRS (e.g., CGR components of a CGRS). In FIG. 4, mapping decision space 400 (“decision space 400”) represents an aggregate (but, not exhaustive) combination of mapping factors, shown as mapping factors 402-412 (collectively, “mapping factors 400”) in FIG. 4, that a CGRS compiler can include in a mapping decision space such as illustrated by example decisions space 400. Using decision space 400, a CGRS compiler (e.g., a MAC layer of a CGRS compiler) can determine alternative mappings of application model operators and dataflow to CGRS hardware resources.

As shown in FIG. 4, mapping factors that can be inputs to decision space 400 can include parallelization factors included in a template, such as par factors 402, which can represent an intrinsic, or application programmer preferred, parallelization of model operators. Decision space 400 can include alternative, and/or optimal, tiling of input data, such as tiling factors 404. Decision space 400 can include boundaries of node and data parallelism, such as node and data parallelism factors 406, which can represent a degree of parallelization of model operators (nodes) and data. Decision space 400 can include boundaries of pipeline stages of underlying CGRS, and/or CGR component, hardware, shown in FIG. 4 as stage boundaries 408.

As illustrated in the examples of FIG. 2, a model can comprise sections. Operators that cannot be executed in parallel cannot be included in the same section of an application model. Similarly, underlying CGR hardware can have limits to the number and/or type of operators that it can perform in parallel, and/or the amount of data it can process (e.g., based on sizes of memory to buffer or store input data and/or computation outputs). Thus, decision space 400 can include boundaries, within a model or graph of a model, between forward and backward sections of the model, shown in FIG. 4, as section and hardware boundaries 412.

Backward nodes can be feedback paths, in the model, to recompute nodes, and the recompute nodes can be factors of decision space 400, shown in FIG. 4 as recompute sections 410. A hardware description, and/or attributes of hardware, of CGRS and/or CGR hardware can be mapping factors in a decision space, and are shown in FIG. 4 as hardware attributes 414.

As illustrated in FIG. 3, a CGRS compiler can include a MAC layer, or component, such as the example MAC of Algebraic Graph Compiler 322 in FIG. 3. A MAC can analyze an application model (e.g., a graph of the model) to determine mapping factors included a mapping decision space. FIG. 4 illustrates MAC 416 as generating mapping factors of decision space 400 from input application model 418. For example, MAC 416 can analyze application model 418 to determine operators and data (e.g., matrices of tensor data) that can be included in sections, and associated section boundaries, and can include these sections and boundaries in decision space 400 (e.g., among section and hardware boundaries 412). MAC 416 can analyze application model 418 to determine operators that can form pipelines (which can comprise a set of alternative pipelines), and associated sections including the pipelines, and can include the pipelines in mapping decision space 400 (e.g., among section and HW boundaries 412).

As they are used in many dataflow applications, neural networks can represent useful application models to illustrate the disclosure, and examples and descriptions of the disclosure make frequent reference to NNs as an example application model. However, this is not intended to limit implementations and it would be apparent to one of ordinary skill in the art that the scope and spirit of the disclosure, and the methods and/or structures of the disclosure, can encompass user application models suitable for execution on CGR systems other than NNs.

As seen in the example of FIG. 4, a CGRS compiler can include a MAC that can generate and/or analyze a computation graph of an application model to determine mapping factors of a mapping decision space. For example, a MAC can traverse a graph, such as in the example of FIG. 2, to determine mapping factors of decision space 400 in FIG. 4.

Based on mapping factors of a mapping decision space, a CGRS compiler can determine alternative configurations of nodes of a graph, such as alternative pipelines and/or sections of a graph. Based on the alternatives, among other mapping factors in a mapping decision space, a CGRS compiler can determine alternative mappings of the graph to CGR hardware to execute the application model.

A CGRS compiler can include a mapping component—referred to herein as a “mapper”—to determine resource mapping alternatives, and/or elect particular mapping alternatives (mapping “decisions”) for mapping operators, and their operands and results, to specific CGRS hardware resources to execute the corresponding application. However, application models, and corresponding graphs, can comprise tens of thousands of operators, and/or billions or even trillions of input/output tensor elements, executable on CGR hardware. Thus, mapping an application model (e.g., mapping a graph) to CGR hardware can require substantial computation time and complexity.

In implementations, to improve efficiency of a CGRS compiler (e.g., a mapper) determining mappings—particularly, optimized mappings—of a model to CGR hardware, a mapping decision space can include a search space representing data and compute nodes of a graph, their relationships (e.g., source and destination nodes within operator dataflows of the graph, as represented by edges of the graph). In particular, a CGRS compiler, or a mapper of a CGRS compiler, a mapping decision space can include a “Dimension-Based Search Space (DBSS). A DBSS can, in particular, represent operators, and/or operator inputs and outputs, and various attributes of these, based on dimensions of operator operands and/or results matrices in a graph. A DBSS can comprise attributes of operators, operands/results, such as operator type, dimensions of operand/results, size (e.g., number of elements) of operand/results dimensions, and so forth.

A DBSS can further comprise a programming interface (e.g., an API or CLI) that a mapper can use to query, based on “named dimensions” of matrices of the graph, operators in the graph, input/output matrices of the operators, source/destination operator relationships, and other attributes of operators and/or matrices of a graph. In a DBSS, the dimension names can correspond dimensions of input (operand) and output (results) matrices. A MAC can analyze a graph to determine operators and their associated input and output matrices in a graph. A MAC can assign particular names (“DIM Names”) to the dimensions of the input/output matrices based on, for example, attributes of their associated operators and/or operator relationships in the graph, and/or cardinality (size) of dimensions of the matrices.

Attributes of operators of a graph can comprise, for example, a type (e.g., a function performed, such as GeMM or ADD) of an operator; a name or identify of an operator; a topological location of an operator within a graph; and/or a relationship of an operator, such as adjacency of an operator to other operators in the graph. Attributes of matrices of a graph can comprise, for example, data types of the matrices (e.g., integer vs floating point, number of bytes/bits of data of elements of a matrix, etc.); cardinality of a dimension (e.g., a row and/or column dimension) of a matrix and/or a shape of a matrix; and/or number of tiles on which a matrix can be sliced. An API of the DBSS can enable a MAC and/or other components of a compiler to query the DBSS, using a “query” DIM Name, to determine operators and/or matrices of graphs, attributes of operator, and/or attributes of matrices of the operators, to perform mapping operations of the compiler.

In this way, using DIM Names, a DBSS can operate as a lexicon (e.g. a lexicon comprising an inventory or record) of operators, operand matrices, results (operator output) matrices, and/or dimensions of operand matrices and results matrices in a graph. Programming interfaces (e.g., function calls of an API) of a DBSS can receive a query DIM Name as an interface argument and can output elements/attributes of elements of a graph included in the DBSS (e.g., operators and/or matrices), and/or attributes associated with elements of the graph, based on an input DIM Name. For example, a MAC can query a DBSS, using a DIM Name, to determine operators having matrices with a dimension corresponding to that DIM Name, and/or matrices of an operator having a dimension corresponding to that DIM Name. Based on the query outputs, the MAC can determine, for example, operators that can form a pipeline and/or a dimension of an output (results) matrix of an operator and a corresponding input (operand) matrix of an adjacent, successor operator on which the two operators can form a pipeline.

To illustrate further, in GeMM operator, two input multiplicand (operand) matrices can be, for example, an M×K and a K×N matrix. A mapper can slice (partition) the multiplicand matrices long dimension M or K. However, if an adjacent, successor operator to the GeMM operator in the graph is, for example an ADD operator, to add an M×1 addend matrix to the M×N GeMM output matrix, then slicing the multiplicand matrices along dimension K does not allow a mapper to form a pipeline between the GeMM and ADD operators, as the K dimension will disappear in the M×N GeMM output matrix. In this case, the ADD operator must await the complete GeMM M×N result before the ADD can operate on that result (adding elements of rows M of the GeMM output matrix to elements of row M of the addend matrix.

On the other hand, by slicing the GeMM output and ADD input matrices along dimension M, the mapper can form a pipe between the GeMM and ADD operators, with the GeMM and ADD operators each processing a 1/M portion of the GeMM output and addend matrices. As the GeMM operator outputs a sum-product of one of the M rows of the input matrix, multiplied by a column of the K×N matrix, the GeMM operator can output that sum-product to the ADD operator to add to a corresponding row element among the M rows of the addend matrix. Using a query interfaces of a DBSS, a mapper can determine that the GeMM and ADD can be pipelined along dimension M but not along dimension K. Based on dimension M, a mapper can determine higher performing section cuts (among alternative section cuts) of a graph than if the mapper sliced the multiplicand matrices of the GeMM operator along dimension K.

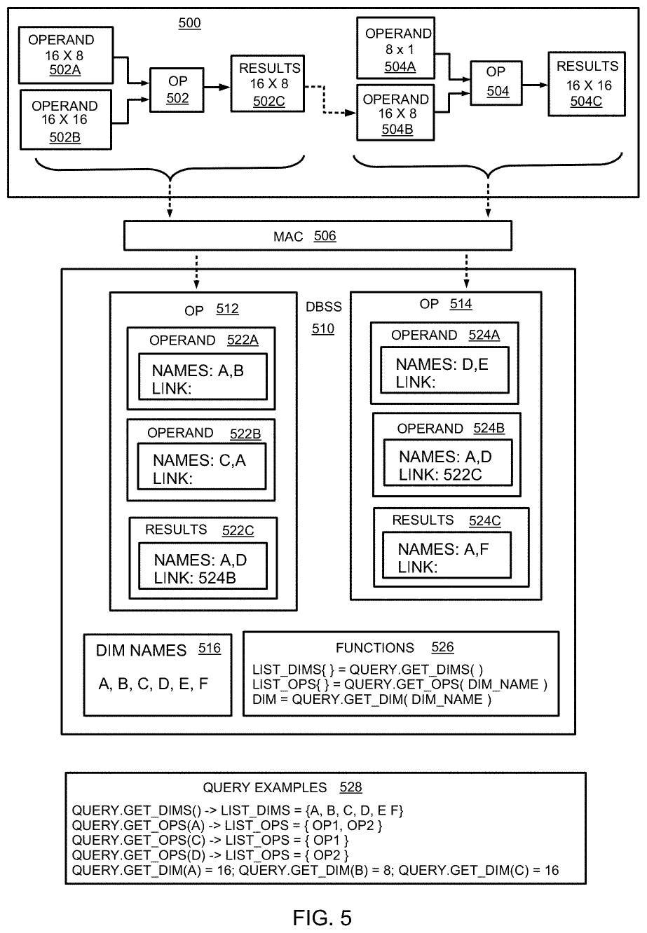

FIG. 5 illustrates an example of a DBSS that a CGRS compiler (e.g., a MAC of a CGRS compiler) can create based on a graph of an application model. In FIG. 5 section 500 represents an example section of a graph (not shown in FIG. 5) that can correspond to an application model. In the example of FIG. 5, for simplicity of the illustration, section 500 is shown having just two operators; however, in implementations a graph can include many thousands of such operators, sections can correspondingly, comprise many more than to operators, and particular operators can be included in multiple alternative sections.

Section 500 is shown in FIG. 5 comprising operators OP 502, having 16×8 matrix operand 502A and 16×16 matrix operand 502B to produce 16×8 matrix results 502C. OP 504 is shown having 8×1 matrix operand 504A and 16×8 matrix operand 504B to produce 16×16 matrix results 504C. Based on results 502C and operand 504A sharing respective column and row dimension 8, operators OP 502 and OP 504 can form a pipeline within a pipeline, such that results 502C from OP 502 can be input operand 504B to OP 504 (indicated in FIG. 5 as the dotted arrow connecting results 502C to operand 504B). In implementations a MAC—shown in FIG. 5 as MAC 506—can traverse a graph containing OP 502 and OP 504 and can include OP 502 and OP 504, and their respective input operand and output results matrices, in a DBSS.

A MAC can include each operator in a DBSS as, for example, a “Named Node” entry of the DBSS (a data structure, such as an object of an object-oriented data structure). A Named Node can include an operator name (e.g., a textual name, or other representation of an operator of a graph), and the operator name can correspond to, for example, types and/or instances of operators of a graph. For example, two GeMM operators of a graph can have operator names, in respective Named Nodes of a DBSS, such as “GeMM1” and “GeMM2”, and two ADD operators of the graph can have operator names, in respective Named Nodes of the DBSS, such as ADD1 and ADD2.

In FIG. 5 Named Node OP 512 is shown corresponding to OP 502, and Named Node OP 514 is shown corresponding to OP 504, of section 500. In FIG. 5, OP 502 and OP 504 can be two instances of the same operator type (e.g., a GeMM or convolution operator), or can be different operators. A Named Node can be identified by an operator name of the operator associated with the Named Node. In FIG. 5, DBSS 510 Named Nodes OP 512 and OP 514 are shown as having operator names “OP”; however, for purpose of illustrating FIG. 5, “OP” is an abstraction of various possible operator types and not intended to imply that OP 502 and OP 504 are necessarily the same operator type.

A Named Node of a DBSS can include “Named DIM” entries for each of a corresponding operator's input operand and output results matrices. While FIG. 5 depicts a single results Named DIM for each of OP 512 and OP 514 (522C and 524C, respectively), it is possible for an operator to have a plurality of output results matrices and a Named Node entry of a DBSS can, then, comprise a plurality of corresponding Named DIM entries.

As MAC 506 traverse a graph, MAC 506 can determine dimensions of operands 502A, 502B, 504A, and 504B and results 502C and 504C. MAC 506 can name dimensions of each of the operand and results matrices of OP 502 and OP 504 such that the DBSS can be searched based on the dimension names to determine operators and their input/output matrices, attributes of the operators and their input/output matrices, and/or relationships of the operators and their input/output matrices. Attributes of the operators can include, for example, a type of operator (e.g., GeMM, ReLu, or ADD) or function performed by that operator, adjacency of operators within a graph, and/or dependencies of an operator on an adjacent operator in the graph (e.g., a dependency on an output of the same or a different adjacent operator in a graph, such as a dependency that can result in a materialization of an output matrix between adjacent operators in a graph).

MAC 506 can assign a dimension name (“DIM Name”) to each of the dimensions of operand and/or results matrices of an operator, and the DIM Names can, for example, assist MAC 506 in determining output/input matrices of adjacent operators that can form a pipeline, and on which dimension the matrices the operators can form a pipeline. For example, MAC 506 can assign the same DIM Name to a shared dimension of respective results and operand matrices of two adjacent operators that can form a pipeline based on the shared dimension. A MAC can assign unique DIM Names to different dimensions of the same matrix, for example to avoid ambiguity over of the dimensions of the matrix that can form a pipeline with an adjacent operator.

To illustrate, in FIG. 5 operand 522A is shown having row DIM Name A and operand 522B is shown having column DIM Name A. A MAC can assign DIM Name A to these dimensions based on, for example, OP 502 being a GeMM operator and these dimensions being dimensions on which that MAC can tile operand 502A and operand 502B to perform the GeMM operation. A MAC can assign DIM Names B and C to these matrices to indicate that these are dimensions on which a MAC cannot tile operand 502A and operand 502B as GeMM inputs to OP 502.

Similarly, in FIG. 5 results 522C is shown having column DIM Name D and operand 524A is shown having row DIM Name D. A MAC can assign DIM Name D to these dimensions based on, for example, operators OP 502 and OP 504 being able to form a pipeline based on these dimensions. In FIG. 5 results 522C is shown having row DIM Name A (which can be, but need not necessarily be, the same DIM Name as the row dimension of operand 502A and column dimension of operand 502B) and column DIM Name D. Operand 524B is also shown having row DIM Name A and column DIM Name D. A MAC can assign DIM Names A and D to these dimensions based on, for example, operators OP 502 and OP 504 being able to form a pipeline based on results 502C and operand 504B having these shared dimensions.

FIG. 5 further illustrates Named DIM 522A, 522B, 524A, and 524B including link entries that can associate matrices of different Named Nodes. A link entry can associate a matrix of one operator with a matrix of another operator, such as an output results matrix of a GeMM operator and an input operand matrix of an ADD operator. The link can associate the matrices based, for example, that the GeMM and ADD operators can form a pipeline. To illustrate further, in FIG. 5 operators OP 502 and OP 504 can form a pipeline based on shared dimension 16, and DIM Name “B”. Thus, as depicted in FIG. 5, Named DIM 522C includes LINK: 524B, which can link results 522C to operand 524B in a pipeline formed by operators OP 502 and OP 504. Similarly, as depicted in FIG. 5, Named DIM 524B includes LINK: 522C, which can link operand 524B to results 522C in a pipeline formed by operators OP 502 and OP 504.

A DBSS can include a list of DIM Names assigned during a graph traversal, shown in FIG. 5 as DIM NAMES 516. While not shown explicitly in FIG. 5, DIM NAMES 516 can include cardinalities of dimensions associated with each of the DIM Names, and/or other attributes associated with each of the DIM Names (e.g., a degree on which a MAC can tile a matrix having a dimension corresponding to that DIM Name). FIG. 5 illustrates the DIM Names, for each Named DIM, as an ordered pair corresponding to respective row and column dimensions of the associated matrices. For example, DIM names “A,B” for Named DIM operand 522A give DIM Name A to the row dimension of operand matrix 502A and DIM Name B to the column dimension of operand matrix 502A.

However, these examples are not intended to limit implementations and it would be appreciated by one of ordinary skill that any form of identifier can identify an operator associated with a Named Node, Named DIM, and/or DIM Name of a DBSS. In a DBSS, Named Nodes and/or operator names, and Named DIMs of operands/results matrices, and/or DIM names of dimensions of operands/results matrices, can be of any form of identifier, and can include alphabetic, numeric, and/or special characters, or a combination thereof. Such names need not be necessarily or particularly human-readable. For example, a Named Node, Named DIM, and/or DIM Name can be an identifier string of significant length or complexity, such a name representing a topological position of an operator/operand/result in a graph of many thousands of such elements. Optionally, Named Nodes and/or Named DIMs of a DBSS can include attributes (not shown explicitly in FIG. 5) of the individual operators and/or their operands/results, such as previously described.

As previously described, a DBSS can comprise functions to facilitate a mapping function using DIM Names to determine operators, operands, and results components of a graph; to determine dimensions of results/operand matrices on which two adjacent operators can form a pipeline; and/or to determine a number of tiles (portions of a matrix), or “degree”, that a mapper can form along a particular dimension of a results and/or operand matrix. To illustrate, DBSS 510 is shown in FIG. 5 including example functions 526 comprising QUERY.GET_DIMS( ), QUERY.GET_OPS(DIM_NAME), and QUERY.GET_DIM(DIM_NAME). In implementations, QUERY.GET_DIMS( ) can, for example, return a list of DIM_names; QUERY.GET_OPS(DIM_NAME) can return a list of operators having a shared dimension DIM_NAME; and, QUERY.GET_DIM(DIM_NAME) can return the size of dimension DIM_NAME, and/or a list of possible sizes of dimensions associated with one or more DIM Names. While not shown explicitly in FIG. 5, functions 526 can include interfaces to query source/destination links among Named DIMs of Named Nodes of DBSS 510. A CGRS compiler (e.g., a function of a CGRS compiler that determines pipelines) can query DBSS 510 based on DIM names to determine operators that can form a pipeline, for example.

In FIG. 5, query examples 528 illustrate possible results (e.g., sets and/or lists) of such functions based on the operator, operand, and results entries (Named Nodes and Named DIMs) of DBSS 510. In implementations, a DBSS can comprise object-oriented programming classes, which can encapsulate data about operators, operands, and/or results (e.g., number and size of operators, number and size of operator dimensions, operator connectivity, etc.) An API of a DBSS, such as interfaces of functions 526, can include programming function calls of object-oriented programming classes.

The examples of functions 526 and query examples 528 are meant only to illustrate a manner in which a DBSS can provide functions to query DBSS 510, using DIM Names, to determine operators, operands/results of operators, and/or particular attributes operators and/or operands/results of operators. However, this is not intended to limit implementations and one of ordinary skill in the art will appreciate that a DBSS can provide many additional or, alternative, query functions, based on DIM Names and/or results of other queries based on DIM Names, and/or functions to create and/or modify entries of a DBSS such as DBSS 510.

From the example of DBSS 510, it can be seen that a mapper can query DBSS 510 to determine, for example, a set operators that can form a pipeline. To illustrate, in traversing a graph, a mapper can perform QUERY.GET_DIMS( ) on DBSS 510 to determine a set of dimensions. The mapper can perform QUERY.GET_OPS(DIM_NAME) using DIM names returned for QUERY.GET_DIMS( ), to determine operators that share common dimensions that can facilitate forming a pipeline. In analyzing a portion of the graph, a mapper can determine, based on results of QUERY.GET_DIMS( ), if successive operators in the graph can form a pipeline based on shared dimensions.

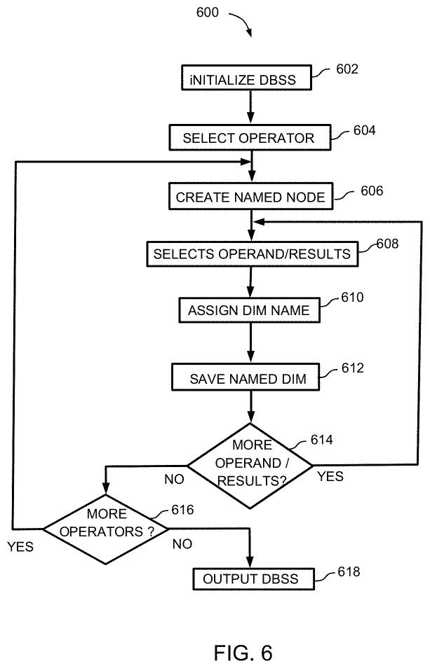

FIG. 6 illustrates example method 600 that a MAC (hereinafter, in reference to method 600, “the MAC”) can use to generate a DBSS (hereinafter, with reference to method 600, “the DBSS”) from a graph (hereinafter, in reference to method 600, “the graph”) of an application model, and for subsequent analysis, using DIM Names, of operators, operands, and results included in the graph to determine mapping alternatives and/or decisions.

In step 602 the MAC initializes or opens the DBSS. If the MAC has not already generated the DBSS, in step 602 the MAC can initialize a new DBSS as an empty space with no Named Nodes. For example, the MAC can, in step 602, generate an empty set of DIM Names, such as DIM Names in the example of DIM NAMES 516 in FIG. 5, prior to the MAC analyzing the graph and assigning any DIM Names. In implementations a DBSS can comprise, for example, an object-oriented “container” class that in turn comprise object-oriented classes for Named Nodes, operator, operand, results, and/or Named DIMs corresponding to respective operator, operand, and/or results of the graph. The DBSS class, and/or classes included in, or associated with, the DBSS class can include functions to query the search space, such as example query functions 526 of FIG. 5.

In step 604 the MAC traverses the graph (or, alternatively, a portion of the graph) and selects an operator and its associated operands and results. In step 604, the graph can be a graph generated or, alternatively, received by the MAC. In implementations, the MAC can, in method 600, traverse the graph to create the DBSS in a topological order, such as a depth-first (e.g., from one “root” operator in a graph to all “leaf” operators in the graph reached from that root), or, alternatively, a breadth-first (e.g., selecting one “root” operator at a particular topological depth of a graph and traversing all neighbor operators at that same topological depth in the graph).

In step 606, if the operator is not already included in the DBSS, the MAC creates a new Named Node to represent the operator. In step 608 the MAC selects an input (operand) or output (results) matrix of the operator and creates a Named DIM entry, in the Named Node, for the matrix. The MAC can initialize the DIM Name and source/destination link of the Named DIM to, for example, a null value.

In step 610, the MAC determines a DIM Name to correspond to each dimension of the matrix selected in step 604. In step 610 the MAC can assign a DIM Name already assigned for a dimension of another matrix (e.g., a matrix of an adjacent operator) or can assign a new DIM Name (i.e., a DIM Name not already determined or assigned).

In step 612, the MAC saves (enters) the DIM Name(s), determined in step 610, in the row and column dimension DIM names of the operand/result Named DIM entry of the DBSS. Optionally, if a DIM Name determined in step 610 has not been already determined or assigned, in step 612 the MAC can enter the newly determined DIM Name in a list of DIM Names in the DBSS (e.g., a list such as DIM NAMES 516 in FIG. 5). If the operator selected in step 608 can form a pipeline with an adjacent operator (such as in the example of results 522C and/or operand 524B of DBSS 510 in FIG. 5), in step 612 the MAC can, optionally, create a link entry in the Named DIM of the operator Named Node in the DBSS to link the matrix selected in step 604 with a corresponding input or output matrix of the adjacent operator.

In step 614 the MAC determines if there are additional operands/results matrices of the operator selected in step 604 for which to create Named DIM entries and/or assign DIM Names. If so, the MAC repeats steps 608 to 614 to generate a Named DIM for a next operand/results matrix among the operand/results matrices of that operator. If, alternatively the MAC determines in step 614 that there are no additional operands/results matrices of the operator selected in step 604, in step 616 the MAC determines if there are more operators in the graph to process.

If the MAC determines, in step 616, that there are more operators in the graph to process, the MAC repeats steps 606 to 616 to generate a new Named Node for a next operator in the graph. In step 616 the MAC can select a next operator based on a manner of traversing the graph in step 606. If, alternatively the MAC determines in step 616 that there are no additional operators to process, in step 618 the MAC outputs the DBSS (or, the new Named Nodes/Named DIMs generated for the DBSS). In step 618 the MAC can output the DBSS to a file, such as a file in a memory (e.g., a host memory) or a file in a storage device (e.g., a disk drive).

A mapper of the CGRS compiler can utilize the DBSS/Named Nodes/DIM Names output in step 618 to determine, for example, section cuts of a graph, pipelines, and/or slicing shapes (dimensions) of operands/results matrices of the operators. Optionally, while not shown in FIG. 6, in step 608 the MAC can output the respective Named Nodes and/or Named DIMs, such that the mapper can process Named Nodes (operators) and/Named DIMs concurrent with the MAC traversing a graph and adding Named Nodes, for subsequently processed operators, and/or Named DIMs for subsequently processed operands/results associated with the subsequently processed operators.

In some implementations the MAC can create a DBSS for each of a plurality of sub-graphs of the larger, input graph. Alternatively, the MAC can perform method 600 over a subset of the input graph, save the DBSS results of that subset, and subsequently perform the method over another subset of the graph, and output an updated version of the DBSS that incorporates the results of performing the method over that next subset of the graph.

A DBSS can include, or can be organized based upon, usage of particular CGR hardware by operators, operands, and/or results in the graph. For example, a DBSS can limit inclusion of operators to only operators that use a particular amount of CGR memory (e.g., memory in computing grids, or DRAM memories). A DBSS can limit inclusion of operators to only operators that use a particular number of CGR units, arrays, and/or processors.

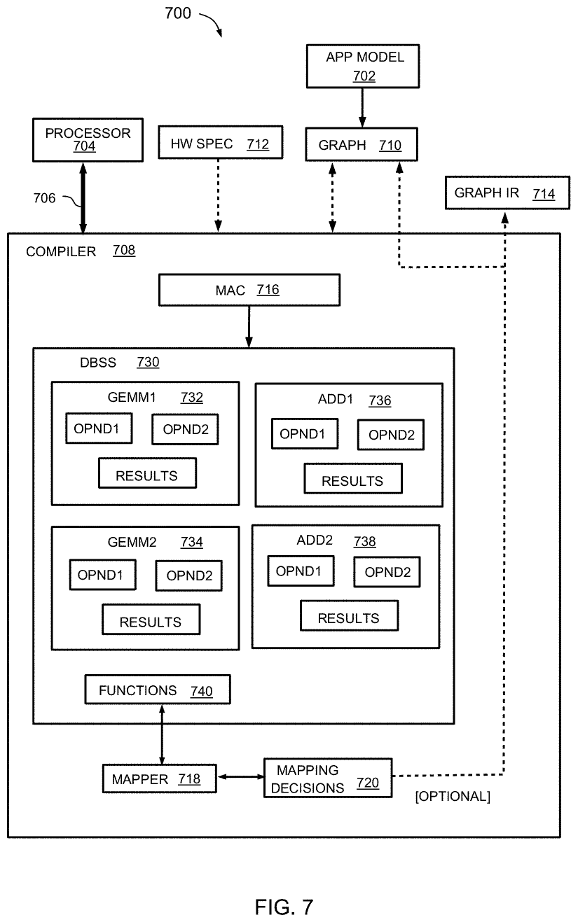

FIG. 7 illustrates an example computing system comprising a MAC configured to create and/or utilize a DBSS. In FIG. 7, computing system 700 is shown comprising application model app model 702, processor 704, graph 710, hardware specifications HW Spec 712, graph IR 714, and compiler 708. In implementations, app model 702 can be any form of application model corresponding to a data-parallel or dataflow applications, such as neural networks and other applications such as natural language processing, image, video, and/audio processing, for example. HW Spec 712 can comprise a description of CGRS hardware to execute app model 702 (e.g., to train and/or execute a machine learning function of app model 702).

Compiler 708 can be, for example, a CGRS compiler for compiling operations of an application model to execute on a CGRS, and/or on CGR hardware of a CGRS. Compiler 708 can be a compiler such as described in the examples of FIGS. 4 and 6. Processor 704 can be any processor, and/or a computing system including a processor, that can execute programs of a CGRS compiler, such as compiler 708. Processor 704 is shown coupled to compiler 708 by means of interface 706. In implementations interface 706 can comprise, for example, an API for executing compiler 708 on processor 704, for compiler 708 to receive input data, such as app model 702 and/or graph 710, and/or for compiler 708 to output data, such as a DBSS, modifications to graph 710, and/or an IR of app model 702 or graph 710 (e.g., an IR of graph 710 after a mapper of compiler 708 has determined mapping decisions).

In implementations, graph 710 can be a computation graph or an auxiliary graph (an input graph, such as graph 710, modified to, for example, reflect mapping decisions of a CGRS compiler) corresponding to app model 702. Compiler 708 can receive app model 702 (e.g., via interface 706 or, another interface of compiler 708 not shown in FIG. 7, such as an API for compiler 708 to receive or to otherwise access app model 702) and compiler 708 can generate graph 710 based on app model 702. Alternatively, compiler 708 can receive graph 710, such as from a storage device or memory storing graph 710 (e.g., storage or memory storing graph 710 from a prior creation of graph 710).

Compiler 708 is shown in FIG. 7 comprising MAC 716, DBSS 730, mapper 718, and mapping decisions 720. In implementation MAC 716 can comprise, for example, a MAC layer, or function, of compiler 708, such as described in the examples of FIGS. 4 and 6. DBSS 730 can be a DBSS such as illustrated by the example of FIG. 5, and can include Named Nodes corresponding to operators of FIG. 7 depicts DBSS 730 comprising Named Nodes (collectively, “Named Nodes 730”) GeMM1 732, GeMM2 734, ADD1 736, and ADD2 738. Operator names of operators among Named Nodes 730 can correspond to types and/or instances operators of graph 710. In FIG. 7 GeMM1 732 and GeMM2 734 can correspond, for example, to two GeMM operators of graph 710. ADD1 736 and ADD2 738 can correspond, for example, to two ADD operators of graph 710.

Named Node GeMM1 732 is shown comprising respective Named DIMs OPND1, OPND2, and RESULTS, collectively, “Named DIMS 732” for GeMM1 732; collectively, “Named DIMs 734” for GeMM2 734; collectively, “Named DIMs 736” for ADD1 736; and, collectively, “Named DIMs 738” for ADD2 738. Named DIMS 732, 734, 736, and 738 can be Named DIMs such as described in the example of FIG. 5, and can comprise DIM Names among a set of DIM Names determined by MAC 716 (e.g., DIM Names such as example DIM Names 516 in FIG. 5) for of operands/results matrices of the operators of graph 710.

In implementations mapper 718 can comprise a function of compiler 708 to map operations and data of app model 702 to CGR hardware resources of a CGRS to execute app model 702. Mapper 718 can, for example, analyze graph 710 and/or query DBSS 730 to determine mapping alternatives and/or decisions to map operators/operands/results and dataflow of app model 702 to a CGRS. In the example of DBSS 730, functions 740 can be functions to enable mapper 718 to query DBSS 730 using DIM Names, such as described in reference to FIG. 5. MAC 716 includes mapping decisions 720, which can comprise outputs of mapper 718, such as mapping alternatives, and/or elected mappings (mapping decisions), based on optimization criteria/metrics associated with executing app model 702 on a CGRS. Mapper 718 can determine and/or generate mapping decisions 720, and compiler 708 (or, mapper 718) can utilize the mapping decisions to determine allocations of particular CGR hardware resources to operators/operands/results of graph 710, and/or to generate configuration files and/or execution instructions to execute app model 702 on a particular CGRS.

Optionally, compiler 708 (e.g., mapper 718) can generate an IR of app model 702 based on mapping decisions 720, illustrated in FIG. 7 by graph IR 714. An IR can, for example, represent of mapping alternatives and/or decisions included in mapping decisions 720. Additionally or, alternatively, and also optionally, compiler 708 (e.g., mapper 718) can modify graph 710 (or, generate a separate, auxiliary graph based on graph 710) to incorporate mapping alternatives and/or decisions included in mapping decisions 720.

FIG. 8 illustrates another example computing system for performing methods of the disclosure. In FIG. 8, computing system 800 comprises computer 810 communicatively coupled to input/output producer/consumer model data 820 via interface 816. Computer 810 is shown comprising CGRS compiler 806 (hereinafter, “compiler 806”), which can be a CGRS compiler similar or equivalent to compiler 708 of FIG. 7, for example.

In implementations compiler 806 can receive an application model and/or graph of an application, shown as app 820A in FIG. 8, from model data 820 and can output results of mapping alternatives and/or decisions of compiler 806 to mapping output 820B. Model 820A can comprise input data to compiler 806 such as, for example, a description of hardware resources of a CGRS (not shown in FIG. 8), and/or an application model and/or graph of an application model. Mapping output 820B can comprise outputs of compiler 806, such as mapping alternatives and/or decisions of compiler 806, CGRS hardware allocations to operators/operands/results of an application represented by app 820A, and so forth. Compiler 806 can output modifications to app 820A, such as modifications to a graph of app 820A, an IR of app 820A, and/or an auxiliary graph of app 820A.

Computer 810 is shown further comprising operating system OS 802, program 804 shown as included in memory 830, firmware 840. OS 802 can, for example, host execution of programs such as program 804. Programs OS 802, program 804, and/or programs of firmware 840 can comprise standalone programs, such as OS kernel programs, firmware, a hypervisor, or any variety of program utilized by a computer to manage execution of the computer. Compiler 806 can comprise one or more programs and OS 802 can, for example, host execution of programs of compiler 806.

Hardware components of computer 810 are shown comprising processors 812A and 812B (collectively, “processors 812), memory 830, interconnect fabric 808, IO Bridge 850, IO Device(s) 860, and IO interconnect 822. Processors among processors 812 can comprise any number, type, and/or combinations of hardware processor, cores of a hardware processor, and/or thread of a hardware processor. Computer 810 can comprise a host computer of a CGRS and processors among processors 812 can comprise a host processor and/or a runtime processor. Processors among processors 812A and 812B can execute programs of computer 810, such as OS 802, program 804, program of firmware 840, and/or programs of compiler 806.

As illustrated in FIG. 8, interconnect fabric 808 can comprise one or more hardware interconnections to interconnect processors 812, memory 830, and/or IO bridge 850 in any combination. In implementations, interconnect fabric 808 can comprise, for example, one or more memory buses, processor nests, and/or switching fabrics, in any combination or arrangement.

Processors 812A and/or 812B can communicate, via IO Bridge 850, with IO device(s) 860 which can comprise one or more IO devices. IO devices can comprise network interface cards, storage media and/or adapters, display adapters, keyboard/mouse adapters, and so forth among peripheral devices of a computer or computing system.

Memory 830 can comprise one or more memories of computer 810, such as main memories, cache memories, flash memories, in any combination or arrangement. Memory 830 can store, for example, instructions, input operands, and/or output results of programs executing in computer 810. As shown in FIG. 8, memory 830 can store instructions, 842, for compiler 806 to traverse a graph, generate a DBSS, and/or determine mapping alternatives and/or decisions. Memory 830 can store, in graph/HW input data 844, input graph data (e.g., model and/or graph data of app 820A) and/or a hardware specification data corresponding to CGRS hardware, for example. Memory 830 can store, in compiler output data 846, results of traversing and/or analyzing a graph, such as DBSS output data, mapping alternatives, and/or mapping decisions. As shown in FIG. 8, compiler output data 83 include DBSS 848, which can be a DBSS such as in the examples of the disclosure and can be generated by compiler 806.

Implementations can comprise a computer program product and can include a computer readable storage medium (or media) having computer readable program instructions of the computer program product incorporated therein. It will be understood by one of ordinary skill in the art that computer readable program instructions can implement each or any combination of operations and/or structure of the disclosure, such as illustrated by the drawings and described herein.

The computer readable program instructions can be provided to one or more processors, and/or other elements, of a computing system or apparatus to produce a machine which can execute, via the processor(s), to implement operations and/or actions similar or equivalent to those of the disclosure. The computer readable program instructions can be stored in a computer readable storage medium that can direct one or more processors, and/or other elements, of a computing system or apparatus to function in a particular manner, such that the computer readable storage medium comprises an article of manufacture including instructions to implement operations and/or structures similar or equivalent to those of the disclosure.

The computer readable program instructions of the computer program product can cause one or more processors to perform operations of the disclosure. A sequence of program instructions, and/or an assembly of one or more interrelated programming modules, of the computer program product can direct one or more one or more processors and/or computing elements of a computing system to implement the elements and/or operations of the disclosure including, but not limited to, the structures and operations illustrated and/or described in the present disclosure.

A computer readable storage medium can comprise any tangible (e.g., hardware) device, or combination of tangible devices, that can store instructions of the computer program product and that can be read by a computing element to download the instructions for use by a processor. A computer readable storage medium can comprise, but is not limited to, electronic, magnetic, optical, electromagnetic, and/or semiconductor storage devices, or any combination of these. A computer readable storage medium can comprise a portable storage medium, such as a magnetic disk/diskette, optical disk (CD or DVD); a volatile and/or non-volatile memory; a memory stick, a mechanically encoded device, and any combination of these. A computer readable storage medium, as used herein, is not to be construed as being transitory signals per se, such as electrical signals transmitted through a wire, radio waves or other freely propagating electromagnetic waves, or electromagnetic waves propagating through a wave transmission medium (e.g., a wave guide or fiber-optic cable).

The computer readable program instructions can be communicated from the computer readable storage medium to the one or more computing/processing devices, via a programming API of a computing system, and/or a communications interface of a computing system, having access to the computer readable storage medium, and/or a programming API of a computing system, and/or a communications interface of the one or more computing/processing devices. The API(s) and/or communications interface(s) can couple communicatively and/or operatively to a network, such as the Internet, a local area network, a wide area network, and/or a wireless network. The API(s) and/or communications interface(s) can receive the computer readable program instructions read from computer readable storage medium and can forward the computer readable program instructions to the one or more computing/processing devices via the API(s), communications interface(s), and/or network.

In implementations, the computer readable program instructions of the computer program product can comprise machine language and/or assembly language instructions, instruction-set-architecture (ISA) instructions, microcode and/or firmware instructions, state-setting data, configuration data for integrated circuitry, source code, and/or object code. The instructions and/or data can be written in any combination of one or more programming languages.

The computer readable program instructions can execute entirely, or in part, on a user's computer, as a stand-alone software package; partly on a user's computer and partly on a remote computer; or, entirely on a remote computer. A remote computer can be connected to a user's computer through any type of network, including a local area network (LAN) or a wide area network (WAN). In implementations, electronic circuitry including, for example, FPGA, PLAs, and or CGRPs can execute the computer readable program instructions by utilizing state information of the computer readable program instructions to configure the electronic circuitry to perform operations or elements of the disclosure, such as illustrated by the drawings and described herein.

In implementations, computer readable program instructions can also be loaded onto a computing system, or component(s) thereof, to cause the computing system and/or component(s) thereof to perform a series of operational steps to produce a computer implemented process, such that the instructions which execute on the computing system, or component(s) thereof, implement the operations or elements of the disclosure, such as illustrated by the drawings and described herein.

The flowchart and block diagrams in the Drawings and Incorporations illustrate the architecture, functionality, and operation of possible implementations of systems, methods, and computer program products according to various implementations of the present invention. Individual elements illustrated in the Figures—such as individual operations illustrated in the flowcharts or individual blocks of block diagrams—can represent a module, segment, or portion of executable instructions for implementing the disclosed function(s). In various alternative implementations, particular operations can occur in an order differing from that illustrated in the examples of the drawings. For example, two operations shown in succession in a diagram of the disclosure may, in a particular implementation, be executed substantially concurrently, or can sometimes be executed in a reverse order, depending upon the functionality involved. It will be further noted that particular blocks of the block diagrams, operations of the flowchart illustrations, and/or combinations of blocks in the block diagrams and/or flowchart illustrations, can be implemented using special purpose hardware and/or systems that, individually or in combination, perform the specified functions, acts, and/or computer instructions.

Terminology used herein, and the examples disclosed, are chosen to illustrate the principles of the implementations, the practical application or technical improvement over alternative technologies, and to enable others of ordinary skill in the art to understand the implementations disclosed herein. The disclosure illustrates various example implementations, and the examples are intended to illustrate principles and aspects of the disclosure, but are not intended to limit implementations, nor intended to be exhaustive of implementations that can be conceived within the scope of the disclosure. It would be apparent to one of ordinary skill in the art that alternative implementations can comprise modifications and combinations within the spirit of the disclosure and the scope of the claims.

As can be seen in the foregoing examples, features of the disclosure can comprise methods and apparati of computing systems. A summary of example implementations of such features includes:

### Example Implementation 1

A method, the method comprising: generating, by a computing system, a dimension-based search space (DBSS) comprising a plurality of Named Nodes, each of the plurality of Named Nodes corresponding to a respective operator among a plurality of operators of an application model and comprising a Named DIM, the Named DIM corresponding to a matrix, among a plurality of matrices of the application model, associated with the respective operator, the Named DIM comprising a DIM Name, among a set of DIM Names included in the DBSS, associated with a dimension of the matrix associated with the respective operator, the DBSS comprising an application programming interface (API) usable by the computing system to determine, based on a query DIM Name, among the set of DIM Names, at least one of an attribute of an operator, among the plurality of operators of the application model, and an attribute of a matrix among the plurality of matrices of the application model;

determining, by the computing system, a first operator among operators of an application model; determining, by the computing system, a first matrix, among matrices of the application model, associated with the first operator; determining, by the computing system, a first DIM Name, among the set of DIM Names, corresponding to a first dimension of the first matrix; and, generating, by the computing system, in the DBSS, a first Named Node among the plurality of Named Nodes of the DBSS, the first Named Node corresponding to the first operator, the first Named Node comprising a first Named DIM corresponding to the first matrix, the first Named DIM comprising the first DIM Name.

### Example Implementation 2

The example of implementation 1, wherein the method of the computing system determining the first operator and the first matrix comprises determining, by the computing system, the first operator and the first matrix by analyzing a directed acyclic graph representing the application model.

### Example Implementation 3

The example of implementation 1, the method further comprising: determining, by the computing system, a second operator among the plurality of operators of an application model; determining, by the computing system, a second matrix, among the plurality of matrices of the application model, associated with the second operator; determining, by the computing system, a second DIM Name, among the set of DIM Names, corresponding a first dimension of the second matrix; and, generating, by the computing system, in the DBSS, a second Named Node among the plurality of Named Nodes of the DBSS, the second Named Node corresponding to the second operator, the second Named Node comprising a second Named DIM corresponding to the second matrix, the second Named DIM comprising the second DIM Name.

### Example Implementation 4

The example of implementation 3 wherein the method of the computing system determining the second DIM Name comprises determining, by the computing system, the second DIM Name to be the first DIM Name.

### Example Implementation 5

The example of implementation 1, the method further comprising determining, by the computing system, a second DIM Name, among the set of DIM Names, corresponding to a second dimension of the first matrix, the second DIM Name different from the first DIM Name.

### Example Implementation 6

The example of implementation 1, wherein the API of the DBSS comprises: a first interface to determine, based on the query DIM Name, an attribute of a second operator among the plurality of operators of the application model, the second operator associated with a matrix having a first dimension corresponding to the query DIM Name; and, a second interface to determine, based on the query DIM Name, an attribute of a second matrix among the plurality of matrices of the application model, the second matrix having a second dimension corresponding to the query DIM Name.

### Example Implementation 7

The example of implementation 1, determining, by the computing system, using interfaces among the API of the DBSS, based on the query DIM Name, that the first operator and a second operator, among the plurality of operators of the application model, can form a pipeline.

### Example Implementation 8

The example of implementation 1, wherein the plurality of operators of the application model correspond to operators of a neural network and the plurality of matrices of the application model correspond to matrices of the neural network.

### Example Implementation 9

A computer program product, the computer program product comprising a computer readable storage medium having first program instructions embodied therewith, wherein the first program instructions are executable by at least one processor to cause the at least one processor to: generate a dimension-based search space (DBSS) comprising a plurality of Named Nodes, each of the plurality of Named Nodes corresponding to a respective operator among a plurality of operators of an application model and comprising a Named DIM, the Named DIM corresponding to a matrix, among a plurality of matrices of the application model, associated with the respective operator, the Named DIM comprising a DIM Name, among a set of DIM Names included in the DBSS, associated with a dimension of the matrix associated with the respective operator, the DBSS comprising an application programming interface (API) usable by a computing system to determine, based on a query DIM Name, among the set of DIM Names, at least one of an attribute of an operator, among the plurality of operators of the application model, and an attribute of a matrix among the plurality of matrices of the application model;

determine a first operator among operators of an application model; determine a first matrix, among matrices of the application model, associated with the first operator; determine a first DIM Name, among the set of DIM Names, corresponding to a first dimension of the first matrix; and, generate, in the DBSS, a first Named Node among the plurality of Named Nodes of the DBSS, the first Named Node corresponding to the first operator, the first Named Node comprising a first Named DIM corresponding to the first matrix, the first Named DIM comprising the first DIM Name.

### Example Implementation 10

The example of implementation 9, wherein the first program instructions are executable by at least one processor to further cause the at least one processor to determine the first operator and the first matrix by analyzing a directed acyclic graph representing the application model.

### Example Implementation 11

The example of implementation 9, wherein the first program instructions are executable by at least one processor to further cause the at least one processor to: determine a second operator among the plurality of operators of an application model; determine a second matrix, among the plurality of matrices of the application model, associated with the second operator; determine a second DIM Name, among the set of DIM Names, corresponding a first dimension of the second matrix; and, generate, in the DBSS, a second Named Node among the plurality of Named Nodes of the DBSS, the second Named Node corresponding to the second operator, the second Named Node comprising a second Named DIM corresponding to the second matrix, the second Named DIM comprising the second DIM Name.

### Example Implementation 12

The example of implementation 9, wherein the first program instructions are executable by at least one processor to further cause the at least one processor to determine, using interfaces among the API of the DBSS, based on the query DIM Name, that the first operator and a second operator, among the plurality of operators of the application model, can form a pipeline.

### Example Implementation 13

A computing system comprises: an application model comprising a plurality of operators and a plurality of matrices associated with operators among the plurality of operators;

a dimension-based search space (DBSS) comprising a plurality of Named Nodes, each of the plurality of Named Nodes corresponding to a respective operator among the plurality of operators and comprising a Named DIM, the Named DIM corresponding to a matrix, among the plurality of matrices, associated with the respective operator, the Named DIM comprising a DIM Name, among a set of DIM Names included in the DBSS, associated with a dimension of the matrix associated with the respective operator; and, an application programming interface (API) usable by a compiler to determine, based on a query DIM Name, among the set of DIM

Names, at least one of an attribute of an operator, among the plurality of operators of the application model, and an attribute of a matrix among the plurality of matrices of the application model; a processor; and,

the compiler, wherein the compiler comprises a Model Analyzer and Compiler (MAC) configured to execute on the processor to: determine a first operator among operators of an application model; determine a first matrix, among matrices of the application model, associated with the first operator; determine a first DIM Name, among the set of DIM Names, corresponding to a first dimension of the first matrix; and, generate, in the DBSS, a first Named Node among the plurality of Named Nodes of the DBSS, the first Named Node corresponding to the first operator, the first Named Node comprising a first Named DIM corresponding to the first matrix, the first Named DIM comprising the first DIM Name.

### Example Implementation 14

The example of implementation 13, wherein the computing system further comprises directed acyclic graph representing the application model; and, wherein the MAC configured to execute on the processor to determine the first operator and the first matrix comprises the MAC further configured to execute on the processor to determine the first operator and the first matrix by analyzing the directed acyclic graph.

### Example Implementation 15

The example of implementation 13, wherein the MAC is further configured to execute on the processor to: determine a second operator among the plurality of operators of an application model; determine a second matrix, among the plurality of matrices of the application model, associated with the second operator; determine a second DIM Name, among the set of DIM Names, corresponding a first dimension of the second matrix; and, generate, in the DBSS, a second Named Node among the plurality of Named Nodes of the DBSS, the second Named Node corresponding to the second operator, the second Named Node comprising a second Named DIM corresponding to the second matrix, the second Named DIM comprising the second DIM Name.

### Example Implementation 16

The example of implementation 15, wherein the MAC configured to execute on the processor to determine the second DIM Name comprises the MAC further configured to execute on the processor to determine the second DIM Name to be the first DIM Name.

### Example Implementation 17

The example of implementation 13, wherein the MAC is further configured to execute on the processor to determine a second DIM Name, among the set of DIM Names, corresponding to a second dimension of the first matrix, the second DIM Name different from the first DIM Name.

### Example Implementation 18

The example of implementation 13, wherein the API comprises: a first interface to determine, based on the query DIM Name, an attribute of a second operator among the plurality of operators of the application model, the second operator associated with a matrix having a first dimension corresponding to the query DIM Name; and, a second interface to determine, based on the query DIM Name, an attribute of a second matrix among the plurality of matrices of the application model, the second matrix having a second dimension corresponding to the query DIM Name.

### Example Implementation 19

The example of implementation 13, wherein the MAC is further configured to execute on the processor to determine, using interfaces among the API, based on the query DIM Name, that the first operator and a second operator, among the plurality of operators of the application model, can form a pipeline.

### Example Implementation 20

The example of implementation 13, wherein the plurality of operators of the application model correspond to operators of a convolutional neural network and/or the plurality of matrices of the application model correspond to matrices of the convolutional neural network.

What is claimed is:

1. A method, the method comprising:
generating, by a computing system, a dimension-based search space (DBSS) comprising a plurality of Named Nodes, each of the plurality of Named Nodes corresponding to a respective operator among a plurality of operators of an application model and comprising a Named DIM, the Named DIM corresponding to a matrix, among a plurality of matrices of the application model, associated with the respective operator, the Named DIM comprising a DIM Name, among a set of DIM Names included in the DBSS, associated with a dimension of the matrix associated with the respective operator, the DBSS comprising an application programming interface (API) usable by the computing system to determine, based on a query DIM Name, among the set of DIM Names, at least one of an attribute of an operator, among the plurality of operators of the application model, and an attribute of a matrix among the plurality of matrices of the application model;
determining, by the computing system, a first operator among operators of an application model;
determining, by the computing system, a first matrix, among matrices of the application model, associated with the first operator;
determining, by the computing system, a first DIM Name, among the set of DIM Names, corresponding to a first dimension of the first matrix; and,
generating, by the computing system, in the DBSS, a first Named Node among the plurality of Named Nodes of the DBSS, the first Named Node corresponding to the first operator, the first Named Node comprising a first Named DIM corresponding to the first matrix, the first Named DIM comprising the first DIM Name.

2. The method of claim 1, wherein the method of the computing system determining the first operator and the first matrix comprises determining, by the computing system, the first operator and the first matrix by analyzing a directed acyclic graph representing the application model.

3. The method of claim 1, the method further comprising:
determining, by the computing system, a second operator among the plurality of operators of an application model;
determining, by the computing system, a second matrix, among the plurality of matrices of the application model, associated with the second operator;
determining, by the computing system, a second DIM Name, among the set of DIM Names, corresponding a first dimension of the second matrix; and,
generating, by the computing system, in the DBSS, a second Named Node among the plurality of Named Nodes of the DBSS, the second Named Node corresponding to the second operator, the second Named Node comprising a second Named DIM corresponding to the second matrix, the second Named DIM comprising the second DIM Name.

4. The method of claim 3 wherein the method of the computing system determining the second DIM Name comprises determining, by the computing system, the second DIM Name to be the first DIM Name.

5. The method of claim 1, the method further comprising determining, by the computing system, a second DIM Name, among the set of DIM Names, corresponding to a second dimension of the first matrix, the second DIM Name different from the first DIM Name.

6. The method of claim 1, wherein the API of the DBSS comprises:
a first interface to determine, based on the query DIM Name, an attribute of a second operator among the plurality of operators of the application model, the second operator associated with a matrix having a first dimension corresponding to the query DIM Name; and,
a second interface to determine, based on the query DIM Name, an attribute of a second matrix among the plurality of matrices of the application model, the second matrix having a second dimension corresponding to the query DIM Name.

7. The method of claim 1, the method further comprising determining, by the computing system, using interfaces among the API of the DBSS, based on the query DIM Name, that the first operator and a second operator, among the plurality of operators of the application model, can form a pipeline.

8. The method of claim 1, wherein the plurality of operators of the application model correspond to operators of a neural network and the plurality of matrices of the application model correspond to matrices of the neural network.

9. A computer program product, the computer program product comprising a computer readable storage medium having first program instructions embodied therewith, wherein the first program instructions are executable by at least one processor to cause the at least one processor to:
generate a dimension-based search space (DBSS) comprising a plurality of Named Nodes, each of the plurality of Named Nodes corresponding to a respective operator among a plurality of operators of an application model and comprising a Named DIM, the Named DIM corresponding to a matrix, among a plurality of matrices of the application model, associated with the respective operator, the Named DIM comprising a DIM Name, among a set of DIM Names included in the DBSS, associated with a dimension of the matrix associated with the respective operator, the DBSS comprising an application programming interface (API) usable by a computing system to determine, based on a query DIM Name, among the set of DIM Names, at least one of an attribute of an operator, among the plurality of operators of the application model, and an attribute of a matrix among the plurality of matrices of the application model;
determine a first operator among operators of an application model;
determine a first matrix, among matrices of the application model, associated with the first operator;
determine a first DIM Name, among the set of DIM Names, corresponding to a first dimension of the first matrix; and,
generate, in the DBSS, a first Named Node among the plurality of Named Nodes of the DBSS, the first Named Node corresponding to the first operator, the first Named Node comprising a first Named DIM corresponding to the first matrix, the first Named DIM comprising the first DIM Name.

10. The computer program product of claim 9, wherein the first program instructions are executable by at least one processor to further cause the at least one processor to determine the first operator and the first matrix by analyzing a directed acyclic graph representing the application model.

11. The computer program product of claim 9, wherein the first program instructions are executable by at least one processor to further cause the at least one processor to:
determine a second operator among the plurality of operators of an application model;
determine a second matrix, among the plurality of matrices of the application model, associated with the second operator;
determine a second DIM Name, among the set of DIM Names, corresponding a first dimension of the second matrix; and,
generate, in the DBSS, a second Named Node among the plurality of Named Nodes of the DBSS, the second Named Node corresponding to the second operator, the second Named Node comprising a second Named DIM corresponding to the second matrix, the second Named DIM comprising the second DIM Name.

12. The computer program product of claim 9, wherein the first program instructions are executable by at least one processor to further cause the at least one processor to determine, using interfaces among the API of the DBSS, based on the query DIM Name, that the first operator and a second operator, among the plurality of operators of the application model, can form a pipeline.

13. A computing system comprising:
an application model comprising a plurality of operators and a plurality of matrices associated with operators among the plurality of operators;
a dimension-based search space (DBSS) comprising:
comprising a plurality of Named Nodes, each of the plurality of Named Nodes corresponding to a respective operator among the plurality of operators and comprising a Named DIM, the Named DIM corresponding to a matrix, among the plurality of matrices, associated with the respective operator, the Named DIM comprising a DIM Name, among a set of DIM Names included in the DBSS, associated with a dimension of the matrix associated with the respective operator; and,
an application programming interface (API) usable by a compiler to determine, based on a query DIM Name, among the set of DIM Names, at least one of an attribute of an operator, among the plurality of operators of the application model, and an attribute of a matrix among the plurality of matrices of the application model;
a processor; and,
the compiler, wherein the compiler comprises a Model Analyzer and Compiler (MAC) configured to execute on the processor to:
determine a first operator among operators of an application model;
determine a first matrix, among matrices of the application model, associated with the first operator;
determine a first DIM Name, among the set of DIM Names, corresponding to a first dimension of the first matrix; and,
generate, in the DBSS, a first Named Node among the plurality of Named Nodes of the DBSS, the first Named Node corresponding to the first operator, the first Named Node comprising a first Named DIM corresponding to the first matrix, the first Named DIM comprising the first DIM Name.

14. The computing system of claim 13, wherein the computing system further comprises directed acyclic graph representing the application model; and,
wherein the MAC configured to execute on the processor to determine the first operator and the first matrix comprises the MAC further configured to execute on the processor to determine the first operator and the first matrix by analyzing the directed acyclic graph.

15. The computing system of claim 13, wherein the MAC is further configured to execute on the processor to:
determine a second operator among the plurality of operators of an application model;
determine a second matrix, among the plurality of matrices of the application model, associated with the second operator;
determine a second DIM Name, among the set of DIM Names, corresponding a first dimension of the second matrix; and,
generate, in the DBSS, a second Named Node among the plurality of Named Nodes of the DBSS, the second Named Node corresponding to the second operator, the second Named Node comprising a second Named DIM corresponding to the second matrix, the second Named DIM comprising the second DIM Name.

16. The computing system of claim 15, wherein the MAC configured to execute on the processor to determine the second DIM Name comprises the MAC further configured to execute on the processor to determine the second DIM Name to be the first DIM Name.

17. The computing system of claim 13, wherein the MAC is further configured to execute on the processor to determine a second DIM Name, among the set of DIM Names, corresponding to a second dimension of the first matrix, the second DIM Name different from the first DIM Name.

18. The computing system of claim 13, wherein the API comprises:
a first interface to determine, based on the query DIM Name, an attribute of a second operator among the plurality of operators of the application model, the second operator associated with a matrix having a first dimension corresponding to the query DIM Name; and,
a second interface to determine, based on the query DIM Name, an attribute of a second matrix among the plurality of matrices of the application model, the second matrix having a second dimension corresponding to the query DIM Name.

19. The computing system of claim 13, wherein the MAC is further configured to execute on the processor to determine, using interfaces among the API, based on the query DIM Name, that the first operator and a second operator, among the plurality of operators of the application model, can form a pipeline.

20. The computing system of claim 13, wherein the plurality of operators of the application model correspond to operators of a convolutional neural network.
